(19) United States
(12) Patent Application Publication
(10) Pub. No.: US 2014/0246859 A1
(43) Pub. Date: Sep. 4, 2014

(54) Hydromotive Machine

(71) Applicant: Henry Obermeyer, Wellington, CO (US)

(72) Inventor: Henry Obermeyer, Wellington, CO (US)

(21) Appl. No.: 14/127,384

(22) PCT Filed: Jul. 15, 2012
(86) PCT No.: PCT/US2012/046827

§ 371 Date: Dec. 18, 2013

Related U.S. Application Data
(60) Provisional application No. 61/519,041, filed on May 16, 2011.

(51) Int. Cl. F03B 13/10; F04D 29/52

(52) U.S. Cl. CPC F03B 13/10; F04D 29/528
USPC 290/54; 415/221

(57) ABSTRACT

Hydromotive machines, e.g. hydroturbines and pumps with integral low head loss shut off valves are described. Arrays of such hydroturbines facilitate power generation within the limited space available at pre-existing gated water control structures. An adjustable pitch hydroturbine runner particularly suited for use with the integral loss shut-off valve provides higher power output and higher specific speed than prior art hydroturbines at low head hydroelectric projects. Arrays of pumps in accordance with the present invention provide high discharge capacity in a limited space, with each individual pump within the array having an integral low head loss valve for shut off and backflow prevention.

### CROSS-REFERENCE TO RELATED APPLICATION

The present application claims priority of U.S. Application No. 61/519,041 filed May 16, 2011.

### FIELD OF THE INVENTION

The present invention relates to hydroelectric generating apparatus and water pumping apparatus and the method of constructing the same. More specifically this invention relates to retrofitting hydroelectric generating apparatus and to pre-existing gated water control structures originally constructed at navigation locks and dams and at water storage reservoirs where hydropower facilities were not originally installed and to fitting pump apparatus (especially for high volume storm water pumping) into limited space such as may be available in an urban area. The disclosed improvements in hydromotive machine shut-off and axial flow turbine runners have diverse applications for fluid conveyance and power generation, a few of many possible application examples being described herein.

### DESCRIPTION OF THE RELATED ART

Hydromotive machines, in particular hydroturbines, have been used in arrays in order to achieve a prescribed flow capacity within a limited upstream/downstream dimension and with minimum apparatus weight and dimensions. Example related patents include U.S. Pat. No. 4,755,690 to Obermeyer, U.S. Pat. No. 4,804,855 to Obermeyer, U.S. Pat. No. 5,825,094 to Hess, U.S. Pat. No. 6,146,096 to Winkler, and U.S. Pat. No. 6,281,597 B1 to Obermeyer et al.

Flow control to hydroturbines within an array of hydroturbines has been by various methods. U.S. Pat. No. 4,755,690 to Obermeyer discloses flow control by means of butterfly valves within the draft tubes. Such valves require relatively large actuators while the valve causes backpressure on the draft tube and a reduction in power generation. Such butterfly valves must be rigid enough and built with sufficient precision to maintain tight contact at seals when closed.

U.S. Pat. No. 4,804,855 Obermeyer describes the use of multi-aperture ring follower valves. U.S. Pat. No. 5,825,094 to Hess also incorporates in its description multi-aperture ring follower valves with the aforementioned operational limitations. U.S. Pat. No. 6,281,597 B1 to Obermeyer et al describes the use of slide gates at the ends of the draft tubes as well and includes in its description the use of ring follower valves. Multi-aperture ring follower valves have the shortcoming that they require that multiple machines be started and stopped simultaneously. This results in having to shut down one or more operable machines even if only one of the machines associated with a multi-aperture ring follower valve must be shut down due to a mechanical or electrical fault condition. It is not possible with vertical ring follower gates to start the lowest rows first at low flows, followed by starting up upper rows after the tailwater is higher (as a result of higher flows). Starting the lower rows first is desirable, if not necessary, at many sites because the natural tailwater elevation is a function of river flow rate, the tailwater elevation being lower at lower flow rates. The flow associated with the lowest row of turbines may need to be flowing into the tailrace in order for the tailwater to rise sufficiently to cover the next higher row of draft tubes. Discharge of water from the draft tube at or below tailwater level is generally required in order to convert most of the energy in the water to useful electric power. A tailwater elevation may or may not be required in order to prevent stall of the draft tube, other factors being residual swirl conditions in the draft tube, Froude number of the draft tube discharge, and the use of any special guiding means near the draft tube exit. At low river flow rates the shortcoming of vertical multi-aperture ring follower valves may be overcome by the use of independently operable single aperture ring follower valves or by the use of horizontally actuated multi-aperture ring follower valves. Within the high power density assemblies required to economically develop the power potential at existing gated structures there is generally not space enough available for installation of the independently operated ring follower valves that would be required for turning on and off individual machines. Ring Follower valves also cause undesirable vibration of the rotating assembly during start up and shut down and are ill-suited to sluicing water (discharging water at partial openings with the generator off, as is required at many facilities after a load rejection). Even though ring follower valves are much smaller than a draft tube gate located at the end of a draft tube, significant force is required for closure.

Slide gates at the ends of draft tubes are heavy, expensive and require large actuators and hydraulic supplies. Additionally, the guide slots result in head losses at the draft tube exits due to losses across the slots themselves as well as losses due to the narrowing of the draft tubes that is required to accommodate the slide gate slots.

Hydromotive machine arrays with ring follower gates require space at one side of each such an assembly for stowing the following ring, and at the other side of each such an assembly for stowing the shutoff gate. Multi-aperture gate leaves minimize assembly size but reduce flexibility of operation because all of the machines controlled by a single multi-aperture ring follower gate must be turned on and off together as a group. If a single machine has an electrical or mechanical fault, all of the machines controlled by the common ring follower valve must be shut down. In the case of a strictly run-of-river hydroelectric plant, if there is not enough water to run all of the machines, and if a continuum of reservoir inflow rates must be precisely duplicated by the hydropower plant discharge, all of the machines (on a common ring follower gate) may need to remain shut down even if there were enough water to run all but one of them. Flexibility of operation is required to accommodate varying flow rates and to maximize overall system availability.

Pre-existing downstream gates may be used to control arrays of hydromotive machines, however, their use, as in the case of multi-aperture ring follower valves results in reduced flexibility of operation and reduced power generation for run-of-river operations. Pre-existing downstream gates have been used to control tailwater for turbines located in existing stop log slots.

The prior art includes generator placed in draft tubes. A first example being small submersible Leroy Summer turbine generator sets marketed in the early 1980's. These machines had no guide vanes. Water entered the runner directly. Residual tangential kinetic energy leaving the runner was partially recovered by a draft tube comprised of concentric cones, the inner one being the housing for a speed increaser and generator. No attempt was made to recover the profile loss of the generator housing which ended abruptly at the end of the draft tube. A second example would be reversible turbines used at tidal plants and for filling and emptying locks. In general such installations have rather poor efficiency when the flow goes through the runner first then over the generator.

U.S. Pat. No. 3,854,848 to Laing discloses a submersible pump with integral back-flow prevention.

Adjustable pitch hydroturbine runners, also known as Kaplan runners are well known in the prior art and universally utilize blades adjustable about radial axes. Small inexpensive machines have been built with simple cylindrical discharge rings. Large vertical machines often have a cylindrical upper half of the discharge ring in combination with a spherical lower half. Large bulb turbines are generally provided with a discharge ring that is spherical both upstream and downstream of the runner centerline. Such discharge rings must be split in order to remove the runner for service. A split discharge ring is expensive. Provision of a block-out in the powerhouse structure that surrounds the split spherical discharge ring is also expensive. A disadvantage of the downstream portion of a spherical discharge ring is that low pressure occurs in the vicinity of the transition to the draft tube. These low pressures, when superimposed on low pressures associated with the turbine blades can cause cavitation and may in some cases determine the turbine cavitation and power limits. Additionally the same change in direction that causes the aforementioned low pressures also diminishes draft tube efficiency due to misalignment of flow entering the draft tube. The Deriaz turbines incorporate adjustable mixed flow runners for lower specific speed turbines required for lower plant cavitation coefficients that result from higher heads and higher settings. Deriaz runner blades are canted downstream (downward in the case of a vertical machine). Adjustable water turbine blades canted upstream are unknown in the prior art.

Vertical slide or roller gates, for example, at the downstream ends of draft tubes may be used to control flow through vertical sets of turbines in one or more rows. Except in the case of a single row of turbines, such an arrangement typically requires that the lower turbine be opened first, followed by the next one up, and so forth, with the result that a fault calling for shutdown of the lowermost turbine generator set requires that all of the turbine generator sets controlled by the same draft tube gate be shut down. A further disadvantage of such an arrangement is that the net downstream force on each gate is high. This dictates the use of expensive friction reducing means such as wheels or rollers, or the use of powerful gate actuators. In the case of hydraulic actuators, this means that large, expensive, and heavy hydraulic accumulators are likely required.

Semi-Kaplan (with fixed guide vanes and adjustable runners) axial flow hydroturbines are generally much less costly than fully regulated turbines while providing nearly identical peak efficiency and output and also providing acceptable efficiency over a wide range of flows. In conjunction with semi-Kaplan axial flow hydroturbines, a valve, gate, or other shut-off means must be provided. Head gates may be used for this purpose, however a partially open head gate upstream of an axial flow turbine can cause severe vibration during start up and shut down. Water flowing under such a gate may drive the lower portion of the runner as a turbine, while the upper portion of the runner rotating in the wake of the partially shut head gate acts as a pump (toward downstream). This situation results in asymmetric forces on the runner and may damage bearings or seals or cause sufficient shaft deflection to cause blade contact to the discharge ring.

Draft tube gates for controlling semi-Kaplan machines fall into several categories, each with certain disadvantages. Ring follower gates for large runners require significant space for stowing on one side the ring portion of the gate leaf and for stowing on the other side the solid portion of the gate leaf. Draft tube gates at the end of the draft tube result in relatively low hydraulic losses but are very large and expensive and difficult to close quickly in the case of load rejection. Draft tube gates located closer to the runner result in head losses from the required openings and guides.

Semi-Kaplan hydroturbines have been built with blades configured to seal to one another when in the fully closed position. This is an inexpensive solution but requires compromises in blade design and turbine efficiency and also results in incomplete shut off due to blade tip leakage. Catastrophic failure may occur if the blade servo mechanism fails to close the blades after load rejection, blade servo mechanisms being generally less robust than draft tube gates, for example, which may be designed to close under the force of gravity alone.

In the case of the prior art of flow and back-flow control to axial flow pumps, slide gates as well as flap type check valves have been used, each imparting unnecessary head losses to the flow and requiring larger more powerful pumps than would otherwise (in accordance with the present invention) be required. The use of cylinder gates conformed to the outside of their associated submersible electric motors in unknown in the prior art. The use of a conical gate in conjunction with a submersible pump for the purpose of backflow prevention, which seals between the diffuser or “straightening vane” shroud and the motor housing is unknown in the art, as is the use of such gates in conjunction with arrays of pumps.

In the case of bulb and pit type axial flow hydraulic turbines with adjustable runners, efficiency is enhanced and cavitation damage minimized by the provision of a spherical discharge ring around the runner. Installation and removal-for-service of the runner requires that the discharge ring be split and also requires that at least the upper half of the discharge ring be removable. This requires a heavier and more expensive discharge ring than would be required if the discharge ring were embedded in concrete. A split also requires extra reinforcing steel in the powerhouse in order to carry structural loads around the required access pit. For vertical Kaplan turbines in particular the discharge ring spherical surface has been commonly omitted above the runner centerline at the expense of turbine efficiency, risk of cavitation damage, and increased fish mortality in order to facilitate runner installation and removal from above.

Cylinder gates were commonly used on Francis type turbines in the early 1900's for load and speed control as well as for shut off. These cylinder gates were located between a set of fixed guide vanes and a Francis type (radial inflow) runner. An electric generator, if used, was located outside of the water passageway and was often driven by a system of pulleys and belts to facilitate use of a higher speed and less expensive generator.

More recently cylinder gates have been used in conjunction with semi-Kaplan and propeller hydroturbines in conjunction with radial inflow guide vanes. In at least one instance, a cylinder gate is located outside of the radial inflow guide vanes. In at least another instance, the cylinder gate is located immediately inside the radial inflow guide vanes. In these cases power is carried by a vertical shaft to a generator located outside of the water passageway.

Cylinder gates significantly larger than the generator OD and extending above headwater level have been used as shutoff devices for vertical axial flow turbines with integrated submersible generators. Such cylinder gates, when open are withdrawn entirely away from the flow path to the hydroturbine.

In conjunction with either individual submersible axial flow turbines or pumps (as a group herein defined as “Hydromotive Machines”), or arrays of the same, the use of cylinder gates configured to seal between the downstream end of the outside of the motor or generator housing and the inside of a conical distributor or diffuser shroud, or an extension thereof, is unknown in the art. Likewise, the use of cylinder gates that closely conform to a generator or motor housing when in the open position is unknown in the art.

It is generally uneconomical to provide adjustable guide vanes or adjustable runners in conjunction with the small turbines used in arrays. Such machines are predominantly provided with fixed guide vanes and with fixed runners which are less expensive and more robust, allowing for the use of coarser trash screens. For their design synchronous speed (in the case of synchronous generators) or near synchronous speed (in the case of induction generators) such machines discharge a fixed amount of water at any given available head. For hydroelectric plants required for environmental reasons to operate in run-of-river mode, this characteristic results in step changes in flow as machines are turned on or turned off. The use of speed adjustment of the operating machines as a group for flow adjustment compensating for turning individual machines on or off is unknown in the prior art. The use of speed adjustment to control residual draft tube swirl to prevent flow separation from the top of the draft tube under low tailwater conditions is also unknown in the art.

Large bulb turbines installed individually or side-by-side in accordance with prior art have several shortcomings in addition to those mentioned above. A large diameter horizontal axis runner, 8 meters in diameter, for example, has a significantly lower plant cavitation coefficient at the top of the runner compared to at the bottom of the runner. Accordingly, the output nearer the bottom of the runner is limited by the cavitation limit at the top of the runner. A large diameter horizontal runner is most efficient in conjunction with a horizontal draft tube, the top of which must be below minimum operating tailwater elevation. This requirement results in an otherwise unnecessarily deep setting of the powerhouse, extra excavation work, and extra concrete work.

### SUMMARY OF THE INVENTION

According to one aspect of this invention, a compact and integrated shut-off means is provided to hydromotive machines such as pumps, turbines, or pump-turbines having submersible motors, generators or motor-generators. In a preferred embodiment in conjunction with hydroturbine, a cylinder gate is provided, that when open, is stowed around the outside of the generator housing or an extension thereof. Said cylinder gate is preferably configured to conform to the exterior of the generator housing so as to offer minimal resistance to flow going past the outside of the cylinder gate toward the turbine inlet, guide vanes and runner. In accordance with a further aspect of this invention, a small 6 mm (measured radially), for example, annular gap may be provided between the cylinder gate and the generator housing to allow for water cooling of the generator. In accordance with a further aspect of this invention, bearing elements on attached to the cylinder gate and to the generator housing serve to guide the cylinder gate between its open and closed positions. In accordance with a further aspect of this invention, said bearing elements may also serve to wipe any accumulated and adhered scum off of the generator housing outside diameter and cylinder gate inside diameter, respectively. In accordance with a further aspect of this invention, holes, slots, or other flow allowing means in the said bearing elements may be provided to allow water flow between the generator housing and the stator outside diameter.

This invention also applies to axial and mixed flow pumps for which a cylinder gate, nearly identical to that herein described for use with axial flow turbines, can provide positive controlled shut off at low cost and in a small space. It the case of a pump, flow is typically opposite to that in a turbine, i.e., from the diffuser vanes (guide vanes in the case of a turbine) then along the motor (generator in the case of a turbine). In accordance with a further aspect of this invention, pumps may be equipped with a conical gate, the upstream end of which seals against the motor housing in a manner similar to the sealing of a cylinder gate to a generator housing as described elsewhere in this specification. Such a conical gate is usefully subject to pressure imbalance and in accordance with a further aspect of this invention, may be configured to shift position in response to the direction of flow, automatically closing upon reverse flow. In accordance with a further aspect of this invention, springs may be used to augment closure, especially if the conical gate must move upward or up an incline to close. In accordance with a further aspect of this invention, such a conical gate may be preferably configured to open to a position causing almost zero head loss when the pump is running. In accordance with this embodiment of the invention, when the pump is shut down, back-flow causes the conical valve to shift toward the impeller and diffuser, until it seats and seals against the diffuser shroud while also sealing to the motor housing. In accordance with this embodiment of the invention, the conical gate itself may be configured for flow passage through the gate when open or both through and around the gate when open, as illustrated in the drawings and described in the detailed description of the preferred embodiments of this specification. In accordance with a further aspect of the present invention, a submersible axial flow pump is provided that incorporates a cylindrical or conical shut off valve, that when closed, seals between the diffuser shroud, or extension thereof, and the impeller end of the motor housing. In accordance with an embodiment of this invention, a cylindrical shut off valve provides balanced hydraulic forces and requires one or more nominally sized actuator(s). Such a cylindrical valve, or “cylinder gate”, is preferably stowed around the outside of the motor housing or extension thereof. In accordance with an embodiment of this invention, such a conical valve is acted upon by imbalanced hydraulic forces that tend to shut the valve against back flow. Such a configuration requires no separate actuator(s). The conical valve, in accordance with a further aspect of this invention, is most advantageously positioned, when open, at a prescribed standoff distance from the motor housing opposite the impeller end of the motor housing. In this prescribed position, said conical valve acts as an axisymmetric guide vane that serves to minimize flow separation from the downstream end of the motor housing, while also being aligned with the flow to which it therefore impedes only minimally.

In accordance with a further aspect of this invention, parallel pumps are provided, one or more of which are fitted with a back flow prevention valve as described above and elsewhere in this specification.

In accordance with a further aspect of this invention, two or more axial flow submersible pumps fitted with cylindrical or conical valves as above described may be located side-by-side or one-atop-the-other.

In accordance with a further aspect of this invention two or more axial flow submersible pumps fitted with cylindrical or conical valves as above described may be arranged in an array of at least two pumps high and at least two pumps wide in order to provide high pumping capacity in a compact form factor, especially within a limited overall length (as measured in the general direction of flow).

The compact integrated shut-off means afforded by the cylinder gate of this invention, especially in conjunction with the adjustable runner able to be removed through the draft tube, facilitates the construction of compact hydropower facilities using arrays of turbines (one above another as well as side-by side). For a given turbine geometry, the weight is proportional to the cube of the runner diameter, while the power output is proportional to the square of the runner diameter. For a given turbine geometry, the weight per kilowatt of power is thus proportional to runner diameter. In accordance with this invention, it becomes more economical and more practical to, for example, manufacture and install 8 turbines each of 3 meters runner diameter instead of 2 turbines each of 6 meters runner diameter. If the turbines are stacked 2 high, the power house width remains unchanged and the length is decreased by roughly 50%, based on homologous water passageway shapes. The weight of the geometrically identical manufactured metal components (such as runner blades) is reduced by 50%. In addition to the cost savings associated with the size and weight reductions, there are transportation and equipment procurement advantages. Smaller assemblies also allow assembly work to be efficiently and reliably performed in factories or other assembly areas not subject to the hazards and expensive logistics of working in a river or other watercourse. In the case of a sufficiently small upstream/downstream length, rail or road shipment of completed assemblies may be enabled.

According to a preferred embodiment of this invention, a cylinder gate is fitted around a submersible generator in a manner that allows it to be moved downstream to a fully closed position and moved upstream to a fully open position. In the downstream position it preferably seats against a compliant sealing element such as a water passageway conforming rubber ring. The rubber ring, in an example embodiment, may be secured between the flange of a turbine distributor shroud and an inlet fairing. The inlet fairing may span between the inlets of a plurality of individual turbine-generator or other hydromotive machine sets. The cylinder gate preferably has a rounded downstream edge such that it forms a smooth water passageway transition from the cylinder gate outside diameter to the distributor hub, which is likewise shaped to create a smooth water passageway surface. The cylinder gate may be actuated by hydraulic cylinders, for example. In the case of actuation by two diagonally opposite hydraulic cylinders used for the purpose of actuating the cylinder gate, the two cylinders may advantageously be placed at top dead center and bottom dead center downstream of the upstream generator support column, if used. In this manner the hydraulic cylinders are located in flow already disturbed by the generator support column. The cylinders may be attached to the generator support column. The upstream generator support column may be used to house power cables, control cables, lubrication lines, pressurization lines, water drainage lines, ventilation ducts, ladders, and the like. 2 or more hydraulic cylinders used to actuate a cylinder gate may be synchronized hydraulically, for example in order to maintain alignment of the cylinder gate throughout its length of travel and in spite of waterborne debris such as sticks of wood that might otherwise cause the cylinder gate to become misaligned and jam. It is advantageous in some cases to provide stay vanes for support of the generator. The stay vanes are preferably upstream extensions of the guide vanes and are bounded at their upstream edge by the path of cylinder gate closure defined by a roughly triangular shaped area bounded by a guide vane, the distributor hub and a line at the cylinder gate parallel to the direction of cylinder gate movement. The downstream boundary of each stay vane is the guide vane to which it is integrated. The inner edge of each stay vane is preferably provided in conjunction with compatibly designed (non-interfering) guide vanes and runner to provide a turbine generator set with integral shut-off means.

In accordance with a further aspect of this invention, not all guide vanes need be connected to stay vanes. For example 8 guide vanes might be used, 4 of which are extended upstream as stay vanes. Alternatively, 12 guide vanes might be used, 4 of which extend upstream to form stay vanes. In cases of non-axi-symmetric inlet conditions, due for example to horizontal and vertical machine spacing being different, the use of no more than 4 stay vanes, preferably located at or near the 12 o'clock, 3 o'clock, 6 o'clock and 9 o'clock positions may be preferably so as not to impede (with stay vanes) circumferential adjustment of streamlines as they approach the guide vane inlets.

In accordance with a further aspect of this invention, each guide vane may be extended as a stay vane and made to closely fit the cylinder gate, which may also be configured with a hard and sharpend downstream edge. In such a configuration the clinder gate can wipe any lodged debris off the leading edge of the stay vanes and then cut it off with the sharp edge of the cylinder gate as the cylinder gate seals to a resilient seat between the distributor shroud and the inlet fairing.

In accordance with a further aspect of this invention, they stay vanes may be closely fitted to the cylinder gate so as to guide the cylinder gate as it is being opened and closed.

In accordance with a further aspect of this invention, slide bearings may be positioned between the cylinder gate and each of any cylinder-gate-guiding stay vanes.

In accordance with one aspect of this invention, hydraulic cylinder gate actuators may be hydraulically synchronized in order to prevent cocking of the cylinder gate during opening or closure. Such synchronization may be by means of cylinders operated in series, by means of piston-type flow dividers, by means of position measurement in conjunction with electronic valve control means, or by means of gear pump type flow dividers, for example.

In accordance with a further aspect of the invention, the cylinder gate may be provided with extra length such that the distance between its upstream and downstream guiding contact with the generator housing is never less than approx. 0.1/4 of the cylinder gate diameter.

According to a further aspect of this invention, a cylinder gate fitted around a submersible generator may be provided in conjunction with compatibly designed (non-interfering) guide vanes and a Francis type (radial inflow) runner.

According to a further aspect of this invention, a cylinder gate fitted around a submersible generator may be provided in conjunction with compatibly designed stay vanes and guide vanes and a modified Francis type (radial inflow) runner. The inlet guide vanes are preferably optimized to direct flow from its generally axial approach direction toward the runner inlet. The modifications of such a runner being arrived at using computational fluid mechanics software to take into account the constraints of axial flow around the generator, in combination with stay vanes delimited by the travel of the cylinder gate, and runner discharge into a straight draft tube.

In accordance with a preferred embodiment of this invention, a cylinder gate is provided for control of flow through one or more hydroturbines in an array of hydroturbines. The cylinder gate is preferably stowed against and supported by the outside of the generator housing when it is in its open position. In this configuration it causes minimum head loss to the hydroturbine even in configurations where incoming flow is parallel to the hydromotive machine axis and of high velocity. The cylinder gate preferably seals at its downstream end to a sealing surface that blends from a hydraulic flow standpoint with the distributor shroud. Said sealing surface is preferably composed of a compliant yet wear and corrosion resistant material such as an elastomer or polymer. The cylinder gate is preferably actuated by synchronized actuators such as synchronized hydraulic cylinders. In order to minimize head losses, two cylinders, for example, may be located at top dead center and bottom dead center. In this manner, the cylinders may be attached to required turbine support columns and may thereby located in the flow shadow of the support columns, resulting in less-than-additive head losses for the support column-gate actuator combination. The two synchronized actuators provide alignment in one axis. Alignment in the second and third axis may be by means of guide means, also at top dead center and bottom dead center. Prevention of rotation along axis 1 and axis 2 allows the cylinder gate to shut tightly even in the presence of debris which it may be designed to cut off. Alignment of the cylinder gate may also be maintained by allowing the downstream inner diameter to slide along the upstream edges of at least some of the inlet guide vanes in the case of a turbine, or along the outlet edge of the diffuser vanes in the case of a pump. Notwithstanding the hydraulically desirable close fit of the cylinder gate to the generator, cooling channels or a cooling annulus may be provided allow water cooling of the generator housing, which might otherwise be impeded by the cylinder gate.

Because the net hydraulic force on the cylinder gate over its full range of position is near zero, the cylinder gate actuators and associated attachment points may be much smaller than the actuators and attachment points associated with a slide gate. The required hydraulic pumps, control valves, and accumulator may likewise be much smaller than those required for actuation of slide gates. The amount of hydraulic fluid at risk of leakage into a watercourse is likewise reduced.

The use of cylinder gates in accordance with the present invention eliminates the need for draft tube gates and their associated guides and sealing surfaces at the discharge end of the draft tube. The draft tubes may thus be terminated adjacent to one another, adjacent to the downstream concrete sill, and adjacent to piers or abutments, if any. This draft tube configuration results in lower draft tube exit velocities and the elimination of head loss caused by sudden changes in water passageway cross section at the location of the otherwise required draft tube gate guides. It should be noted that there are other alternatives to controlling flow through a hydromotive machine. These include: upstream slide gates, draft tube butterfly valves, and slide gates within the length of the draft tube. The advantages of the present invention apply equally, if not more, to each of these. Compared to upstream slide gates, the cylinder gate of the present invention is more readily moved out of the path of incoming flow when open, is much lighter in weight and of lower cost, and does not cause vibration inducing asymmetric flows as it is being opened or closed. Compared to a draft tube butterfly valve the cylinder gate of the present invention is lighter weight and lower cost and does not contribute to draft tube (hydraulic) losses. Compared to slide gates within the length of the draft tube, the present invention is lighter weight and less expensive, does not prevent the installation of immediately adjacent rows of additional machines, and does not interfere with the hydraulic efficiency of the draft tube.

In accordance with a further aspect of this invention, a hydroturbine is provided wherein the generator is within a draft tube and downstream of the runner. The generator is preferably radially supported on its upstream end by shaft extending upstream of the runner into a guide bearing supported by the distributor hub. The guide bearing may be water lubricated, for example. The generator housing is preferably supported on its downstream end by a plurality of struts, which may be streamlined vanes, that secure the generator with respect to four degrees of freedom, namely against downstream thrust, against the torque about the turbine axis of rotation, and against translation in the plane normal to the turbine axis of rotation (vertically and horizontally in the case of a horizontally oriented hydroturbine generator set). Preferably said struts provide exact constraint of the generator, i.e., they do not over-constrain the generator. Over-constraint can result in unpredictable states of tension and compression in said streamlined vanes resulting in unpredictable resonant frequencies. Residual stress from welding, bolt tightening, or from external structural loads, for example, can shift a strut resonant frequency to correspond with an inherent excitation frequency such as rotational speed, blade passing frequency, etc., resulting in resonance and failure. Said struts may be asymmetrically configured so as to also serve as diffusers and thereby convert residual tangential velocity to incremental energy recovering pressure gradient across the runner. Tie rods immediately downstream of the runner as used in conjunction with prior art hydroturbines to secure a generator within a draft tube are omitted in order to accommodate the cylinder gate and to maximize hydraulic efficiency. The cross section drag of the generator in the draft tube may be minimized by deliberate optimization and coordination of other aspects of the water passageway. Counter-intuitively, the profile (energy) loss associated with the generator in the water passageway may be minimized so as to be roughly equal to or even less than the profile (energy) loss of a conventional runner hub fairing used in the most common axial flow hydroturbine configuration wherein flow exits the runner and passes over a runner hub fairing and then into the draft tube. Although the profile area of the generator is much larger than the profile area of the runner fairing, the lower velocities passing over the generator result in a lower profile (energy) loss. Conservation of angular momentum causes fluid with even a small angular velocity component exiting the turbine blades nearest the runner hub to attain a much higher angular velocity as the runner fairing reduces in diameter further downstream. The result is that a long runner hub fairing terminating at less than approximately 0.2 D (where D=rubber diameter) or even in a sharp point provides little or zero net gain in turbine efficiency.

By transitioning within the draft tube from the runner hub diameter at the blade exit to the diameter of the generator housing, the tangential velocity components of flow exiting the runner are usefully reduced in a manner that imparts incremental suction to the runner. Any remaining tangential velocity component may be recovered further downstream by the use of diffuser vanes at a position in the water passageway with low velocities where the loss resulting from such diffuser vanes is minimal. In accordance with an aspect of this invention, such diffuser vanes may be located downstream of the open position of a cylinder gate located around the periphery of a generator. Such an arrangement can be configured with an overall length of the draft tube of approximately 4 D, which falls within the range of conventional axial flow hydroturbine draft tubes, in conjunction with which the generator is located elsewhere. The omission of both the generator and the flow shut off gate as contributors to overall assembly length greatly facilitates the installation of hydroturbines in accordance with this embodiment of the invention into restricted spaces such as into stop log slots at pre-existing water control structures and into radial gate assemblies, for example. By dividing the available vertical (from operating tailwater elevation to gate invert, for example) and horizontal dimensions (distance between piers, for example) of the available water passageway into discrete rows and columns of turbines, a runner diameter may be selected to attain the desired (and presumably constrained) dimension parallel to the direction of flow. This embodiment provides a favorable runner-diameter-to-overall-length ratio while eliminating runner hub fairing profile losses, the efficiency penalty of a drag inducing submerged rotor of a rim generator of (favorable runner-diameter-to-overall-length ratio prior art) and the efficiency penalty of the shutoff gate required for prior art hydroturbine generators including those of rim generator type.

In accordance with a further aspect of this invention, a hydroturbine with an adjustable runner is provided having a plurality of blades, 3, 4, or 5, for example, each rotatable about an axis angularly equally spaced from the axis of each adjacent blade, with the axes as a group lying on a common cone with its apex downstream and with the blades extending slightly (5 degrees, for example) upstream and radially outward therefrom. The spherical discharge ring surface required for minimization of blade tip gaps is extended upstream while being truncated downstream, preferably at a station where it becomes tangent to a coaxial cylinder equal in diameter to the spherical discharge ring. The slight velocity increase upstream of the runner entrance is tolerable from a cavitation standpoint because the water has not yet gone through the runner and the pressure is still relatively high at this location. This velocity increase may be minimized by narrowing or necking down the distributor hub upstream of the runner in order to accommodate a greater proportion of the total flow nearer to machine axis. Such an arrangement is advantageous compared to the prior art adjustable axial hydroturbine runners for the following reasons:
1) The runner may be installed or removed from the turbine through the draft tube and without the need for the discharge ring being disassembled. This allows use of a less expensive discharge ring that need be neither split nor removable and which in turn allows construction of a less expensive powerhouse.
2) Because the runner does not need to be removed upwardly from its operating position, machines may be stacked one upon the other while maintaining access to all runners. Accordingly, a hydropower installation comprised of small machines can have the same output as a powerhouse comprised of larger machines while also having a substantially reduced footprint, i.e., projected area on a horizontal plane. This results, for example, in being able to substitute four machines (two machines high×two machines wide, for example) of half the runner diameter to achieve the same hydraulic capacity and output with a lower cost powerhouse of half the length and half the footprint (projected area on a horizontal plane).
3) Because the water passageway cross sectional area is increased at the runner exit, and because the water is not caused to flow over the relatively severe transition between spherical discharge ring and tapered draft tube, runner cavitation limits and therefore, power output limits are improved.
4) Because of better alignment of flow exiting the runner with the interior of the draft tube, draft tube efficiency, and therefore turbine efficiency as well, is improved.
   The net result is an axial flow turbine that is less expensive to manufacture, less expensive for which to build the required concrete structure, i.e., powerhouse, and has greater power output compared to the prior art.

In accordance with yet another embodiment of this invention, hydroturbine generators or pumps as described herein may be operated at speeds independent of the lines frequency. In the case of an installation comprised of a plurality of hydromotive machines of fixed geometry, the flow rate through each machine may be varied by varying its speed even though its geometry is not varied. By so adjusting the flow rate of (preferably all) machines in operation, the number of machines running may be increased or decreased without creating step changes in flow rate. The speed may also be usefully optimized at any point in time to attain certain objectives, for example, to maximize plant efficiency, to maximize plant output, to prevent cavitation, to maintain uniform flow rates, and to prevent separation from the top of the draft tube in the case of low tailwater, for example. Furthermore, operating speeds at any instant in time may be adjusted to attain the instantaneous best combination of the above objectives. Machines in different rows, i.e., at different elevations, may be operated at different speeds in accordance with differing cavitation limits resulting from different settings relative to tailwater.

In accordance with a further aspect of the invention, power from hydroturbines with induction generators may first flow to one or more “active front end” portions of a regenerative inverter located at the (typically submerged) turbine assembly and thence along a common DC bus, and thence to the line frequency interface portion of the inverter system. This arrangement results in simplified movable electrical power transmission means between the movable assembly of multiple turbine generator sets and the fixed power transmission line. For example, instead of a 3 phase alternating current cable from each of many turbine generator sets to a fixed switchgear system, 2 shared direct current conductors may be used in the form of a single 2 conductor cable or 2 conductor movable or disconnectable bus bar, for example.

In accordance with a further aspect of the invention, power for operation of auxiliary devices such as hydraulic pumps and control devices may be generated within one or more turbine-generator sets, by use of an auxiliary winding, for example.

In accordance with a further aspect of the invention, a fiber optic line communications cable may be incorporated into the power cable for control and monitoring signal.

In accordance with a further aspect of the invention, the fiber optic line may be installed in a sheath within the power cable assembly in a manner that allows the fiber optic line to be readily replaced without replacing the power cable assembly as a whole.

In accordance with a further aspect of this invention, an array of hydroturbines is rotatably mounted in a water passageway such that water from either direction, relative to the fixed structure, may be allowed to flow through the array of turbines in the same direction, relative to the turbines. In this manner, high turbine efficiency, 90%, for example, may be attained with either direction, relative to the fixed structure in which the turbines are installed.

In accordance with a preferred embodiment, such physically reversible arrays of turbines may also be operated at variable speed in conjunction with an inverter system, for example. With such a combination, high efficiency may be maintained over a wide range of head and with flows in either direction. Such bi-directional operation at varying head is desirable and advantageous for recovering energy from water used to fill and empty navigation lock chambers, and in conjunction with tidal energy plants, for example.

In accordance with a further aspect of this invention, hydromotive machines installed one above another may be operated at differing specific power levels in accordance with instantaneous plant cavitation coefficients, the lower hydromotive machines being operated at higher specific power levels, by adjusting the speed of the turbine generator sets, for example. [0047] In accordance with a further aspect of this invention, hydroturbines installed one above the other may be operated in a sequence such that the lower machines are started first and shut down last so as to be able to efficiently operate the plant with tailwater levels lower than the tops of the draft tubes of the upper row hydroturbines. After flows are established by flow through all of the lower hydroturbines, tailwater may rise sufficiently to begin operating the next higher row of machines.

In accordance with a further aspect of this invention, horizontal axial flow pumps, installed one above the other, may be sequenced such that the lowest row operates first with intake levels sufficient for vortex entrainment free operation of the lowest row. As intake levels continue to rise with the lowest row operating, the next higher row may be started as a group or individually once the intake levels are high enough to prevent vortex entrainment with respect to said next higher row. Such sequencing serves also to suppress cavitation.

In accordance with a further aspect of the invention, an installation of generally horizontal axial flow hydromotive machines, at least some installed one above the other, may be installed in generally horizontal rows of varying width, the smaller rows being at the bottom. In this manner, the hydromotive machine installation intake shape may be made to more closely align with trapezoidal flow channels at the installation inlet, outlet or both.

In accordance with a further aspect of the invention, one or more hydromotive machines may be movably installed upstream of pre-existing water control gates, wherein the tailwater conduit between said one or more hydromotive machines and said pre-existing water control gates may be sealed off from atmospheric pressure and in conjunction with which the pressure above the top of the opening of at least one of the pre-existing water control gates may be maintained at a pressure lower than atmospheric pressure, by means of hydraulically driven air entrainment and removal or with a vacuum pump, for example. Such an arrangement may be used to lower the effective tailwater elevation to an elevation below the physical elevation of all or a portion of affected draft tube outlets. Such an arrangement may be particularly beneficial in the case of hydroturbines stacked one above the other, as may be require in order to meet output objectives within a waterpassageway of limited size.

### BRIEF DESCRIPTION OF THE DRAWINGS

FIG. 1 shows a prior art hydroturbine installation with a prior art cylinder gate.

FIG. 2 shows a prior art cylinder gate as used in a Francis turbine.

FIG. 3 shows a prior art bulb turbine powerhouse.

FIGS. 4a and 4b show a submersible turbine generator set with the cylinder gate open and with the cylinder gate closed, respectively.

FIGS. 5a, 5b, 5c, 5d, and 5e show a submersible turbine generator set with cylinder gate in various views.

FIG. 6 shows a submersible turbine generator set with a mixed flow runner and a cylinder gate.

FIG. 7a shows a sectional elevation of a powerhouse with cylinder gate controlled high specific speed turbines stacked two high.

FIG. 7b shows a plan view of the powerhouse of 7a.

FIG. 8 shows a sectional elevation drawing of an assembly of cylinder gate controlled submersible turbine generator sets installed as a replacement for a submergible radial gate.

FIGS. 9a, 9b, and 9c show views of an example runner hub mechanism suitable for operation of the high specific runner in accordance with this invention.

FIG. 10 shows a pump with cone valve.

FIG. 11 shows a pump with cone valve.

FIG. 12 shows a sectional elevation of a water turbine with a cylinder gate and generator in the draft tube.

FIG. 13 shows a submersible hydroturbine with a cylinder gate and generator in the draft tube in conjunction with a Francis runner.

FIG. 14a shows a plan view of an array of hydroturbines that utilize flows in either direction by being rotated 180 degrees about a vertical axis.

FIG. 14b is a view of the inlet end of the array of turbines of FIG. 14a.

FIGS. 15a, 15b, and 15c are exit end view, sectional elevation view, and entry end view, respectively of a hydroturbine with an adjustable runner with canted blade pivot axes, generator in the draft tube, and a cylinder gate shown in the open position.

FIGS. 16a, 16b, and 16c are the same views as FIGS. 15a, 15b, and 15c, except with the cylinder gate shut.

FIG. 17 is a sectional elevation of a hydropower plant with two staggered rows of turbines, one above the other.

FIG. 18 is a sectional elevation of an array of hydroturbines installed in a gate service stop log slot, in conjunction with which air is evacuated from the water passageway between the turbine array and a downstream control gate.

FIG. 19 illustrates the use of multiple air gap axial flux permanent magnet generators in conjunction with cylinder gates and mixed flow runners.

FIGS. 20a, 20b, 20c and 20d illustrate a hydroturbine with the generator and cylinder gate in the draft tube in conjunction with a fixed pitch runner.

FIG. 21 illustrates the use of an external rotor permanent magnet generator in conjunction with hydroturbine in accordance with the present invention.

FIG. 22 shows a cut-away view of a turbine with a cylinder gate stowed when open around a generator located within the draft tube.

FIGS. 23a, 23b, and 23c show inlet end, cut-away, and exit end views of the turbine of FIG. 22.

FIG. 23d shows velocity triangles at stations 1, 2, 3, 4, and 5 for the turbine of FIGS. 23a, 23b, and 23c.

FIG. 24 shows cross sections of the turbine of FIGS. 22 and 23a, 23b, and 23c.

FIG. 25 shows approximate water passageway area as a function of axial position through the water turbine of FIGS. 22, 23a, 23b, and 23c.

FIG. 26 shows the water turbine of FIGS. 22, 23a,23b, and 23c with the cylinder gate open.

FIG. 27 shows the water turbine of FIGS. 22, 23a,23b, and 23c with the cylinder gate closed.

FIG. 28 shows the inlet end of an array comprised water turbines similar to the one shown in FIGS. 22, 23a, 23b, and 23c.

FIG. 29 shows the outlet end of an array comprised water turbines similar to the one shown in FIGS. 22, 23a, 23b, and 23c.

### DESCRIPTION OF THE PREFERRED EMBODIMENTS OF THE INVENTION

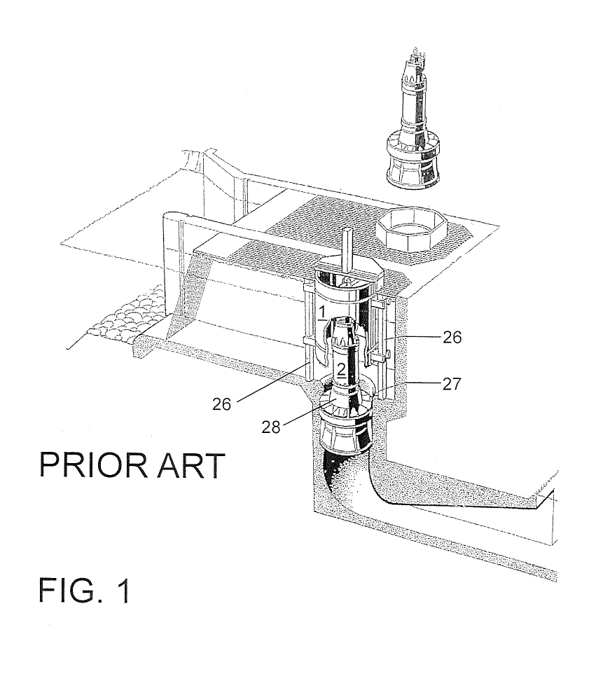

Referring to FIG. 1, a prior art turbine installation utilizing cylinder gates is shown. The illustrated prior art cylinder gates 1 are sized sufficiently large to allow complete removal of a hydroturbine-generator set through a closed cylinder gate 1. The large space between the cylinder gate 1 and the generator 2 housing outside diameter limits the use of such a cylinder gate 1 to vertical installations wherein the cylinder gate 1 extends above water level in its closed position. Furthermore, the configuration of the vertical guides 26 requires that they be positioned radially distant from the distributor inlet 27 in order to not cause unacceptable disturbance to the turbine inlet flow. The illustrated generator 2 housing outside diameter is too small for an economically designed direct drive generator, a gear speed increaser 28 thus being required. The gear speed increaser 28 generally results in a shorter turbine generator life with lower reliability compared to a direct drive alternative.

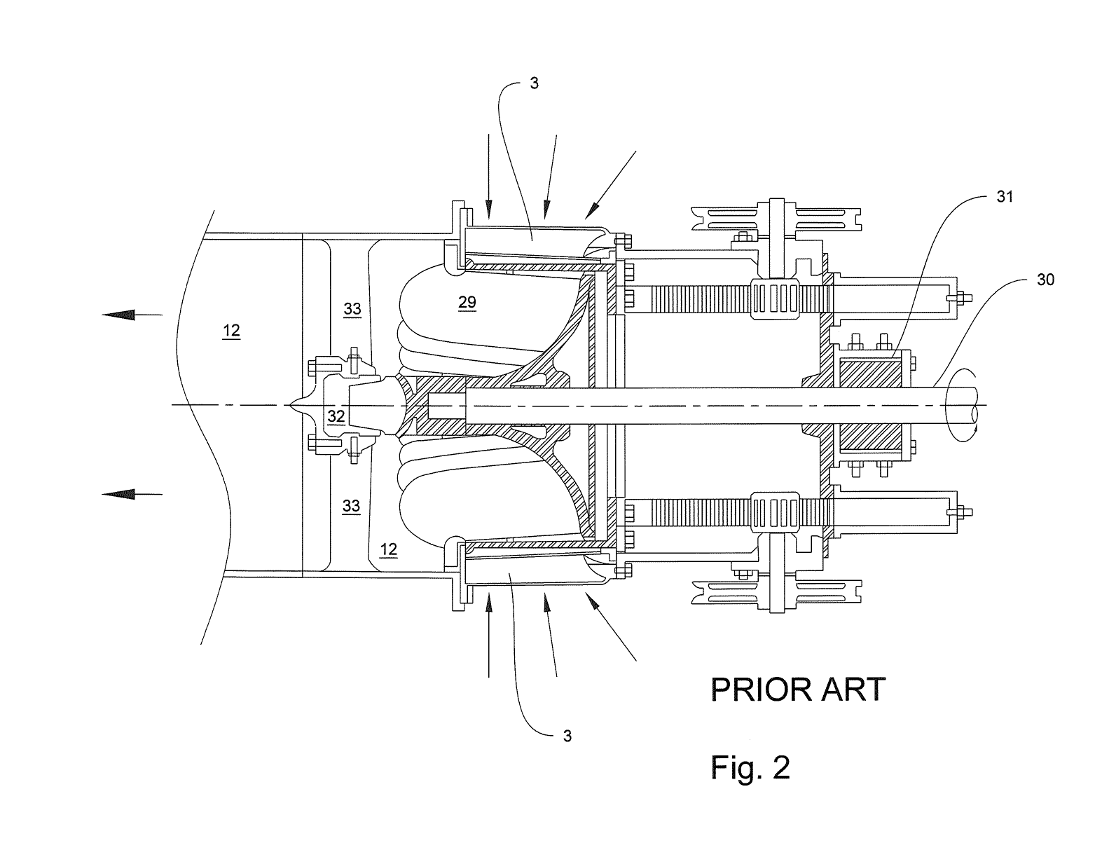

FIG. 2 shows a prior art cylinder gate 1 as used around year 1900 on cylinder gate controlled Francis turbines. Such a cylinder gate configuration is not suitable for use with a submersible axial flow turbine-generator set because support of the runner 29 and shaft 30 through the guide vanes 31 is limited by the long load path from the draft tube 12 to the nearest point where connection may be made to a shaft-supporting bearing 31 while clearing the cylinder gate 1 and its travel path. It should be noted that in this prior art example a bearing 32 is required in the draft tube 12 in order to adequately support the turbine shaft 30. Such a bearing 32 and associated support structure 33 would not be hydraulically acceptable in conjunction with a high specific power axial flow hydroturbine, the control of which is enabled by the present invention.

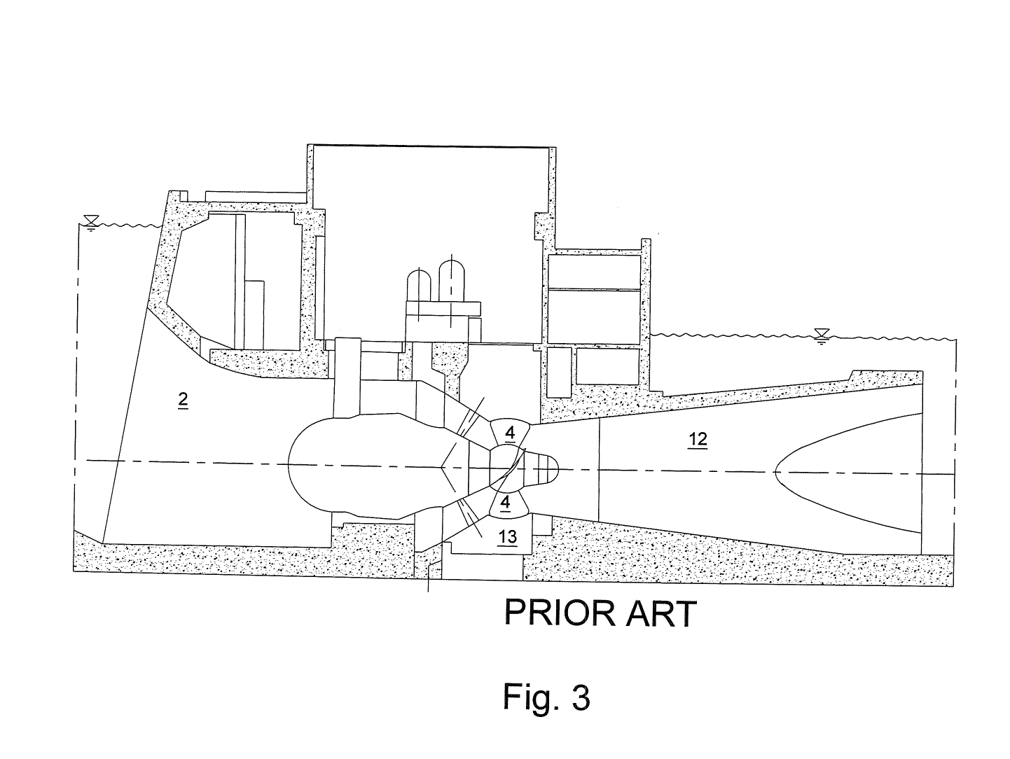

FIG. 3 shows a prior art large bulb turbine installation in cross section. Access for installation, repair and maintenance to such a machine dictates that, although such machines may be situated side-by-side, they may not be stacked one atop the other or in rows one atop the other. The component weight per kilowatt of such a prior art design and the overall length of such a prior art design is a multiple of that associated with designs in accordance with the present invention.

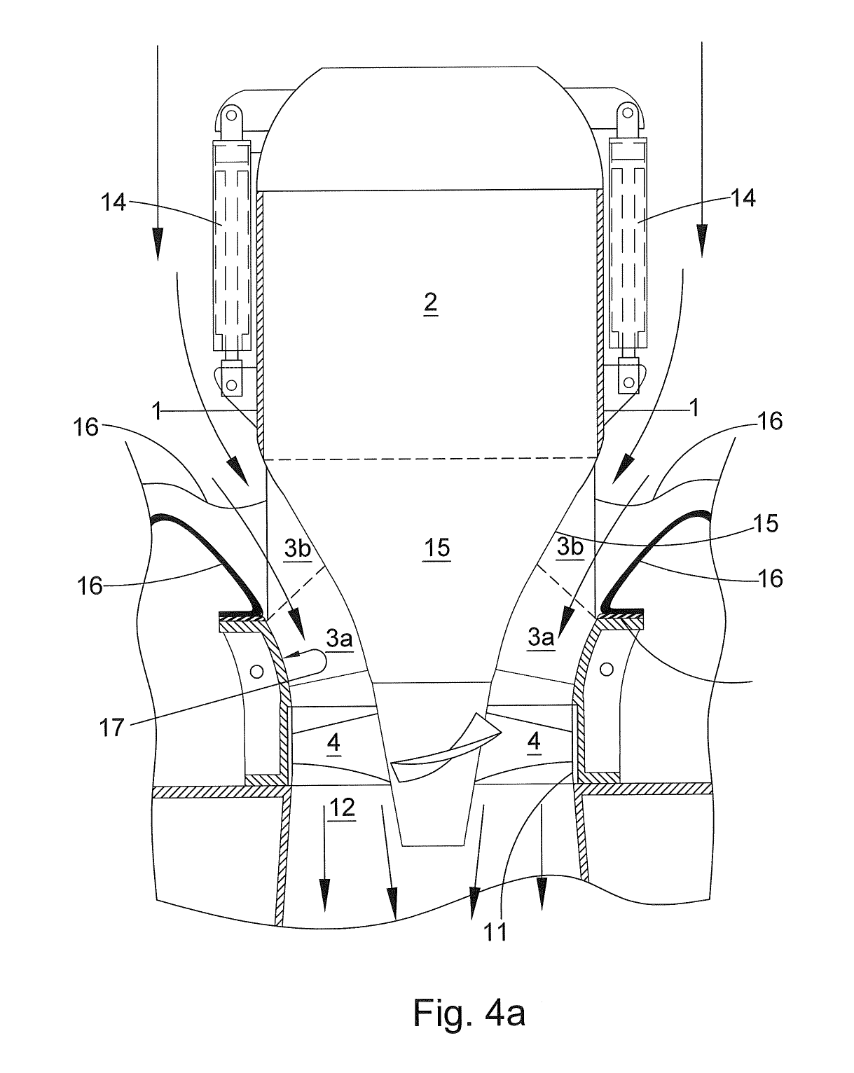

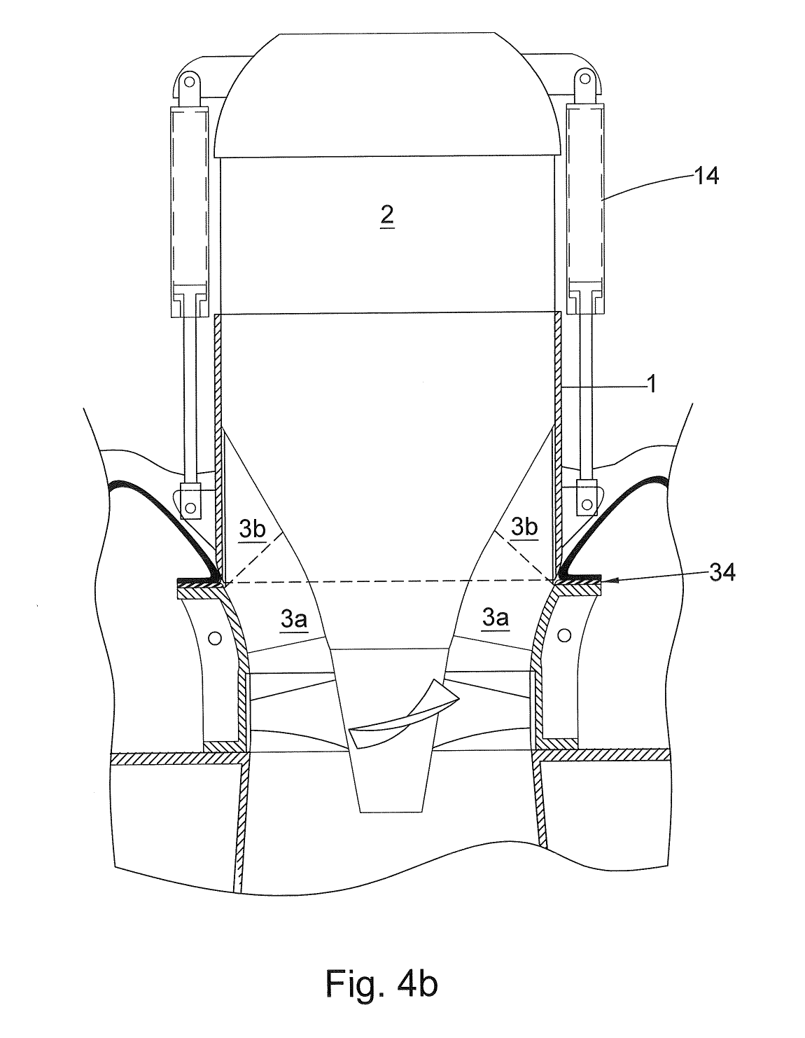

Referring to FIG. 4a, cylinder gate 1, operated by hydraulic cylinders 14 is shown open. Cylinder gate 1 conforms to generator housing 2 when open. Cylinder gate 1 seals at its upstream edge to generator housing 2 when closed as shown in FIG. 4b. Clearance of 6 mm, for example, may be provided between the cylinder gate and the generator for the flow of cooling water. Stay vane 3b lies generally parallel to the incoming flow and transitions into guide vane 3a at the location where the flow becomes contained between the distributor hub 15 and the distributor shroud 17. Compliant cylinder gate seat 34 provides a tight seal to the downstream end of the cylinder gate 1 when closed as shown in FIG. 4b.

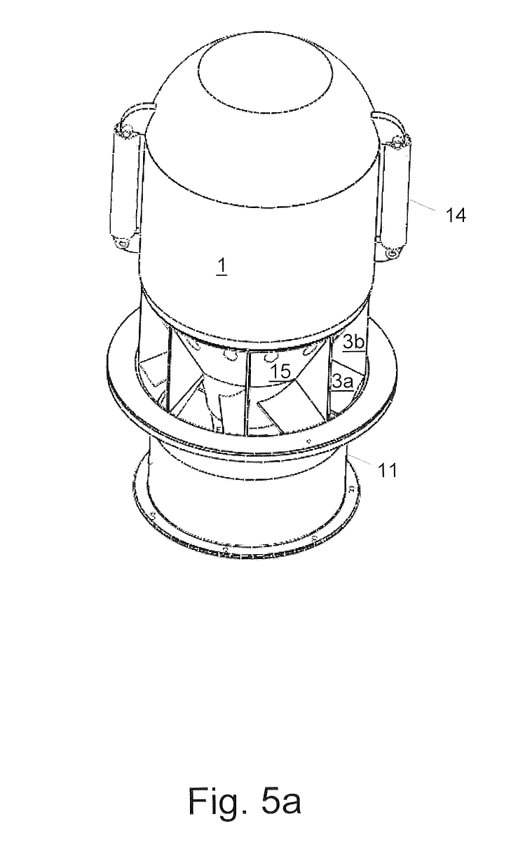

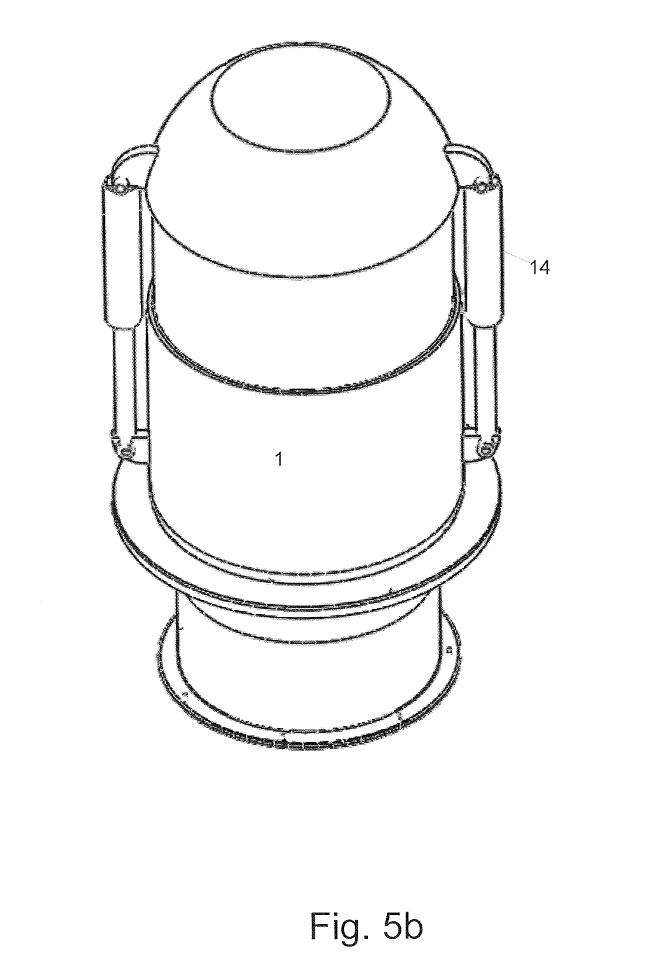

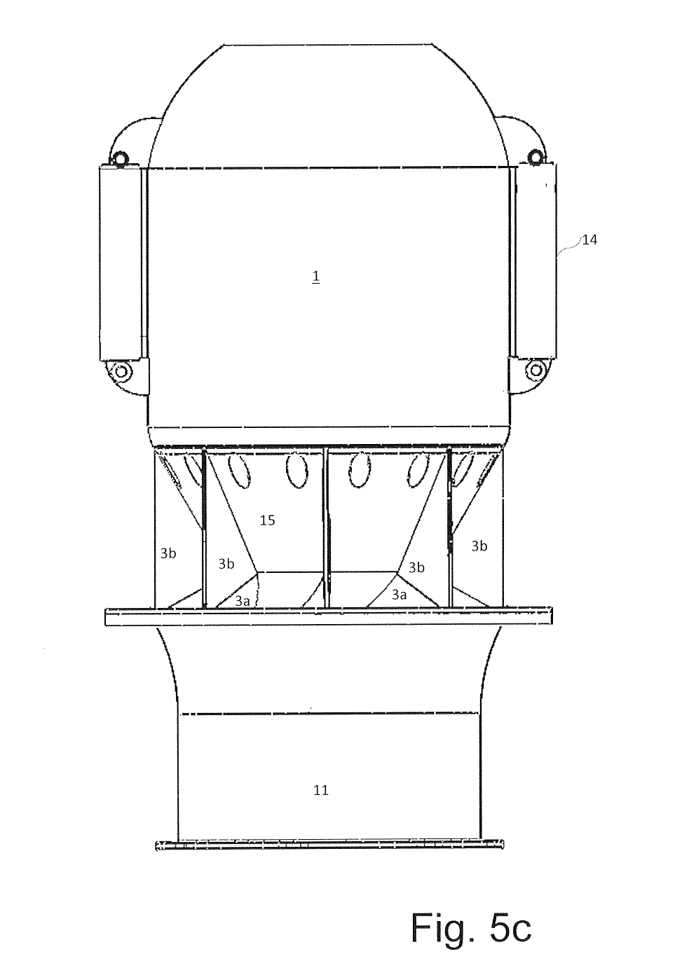

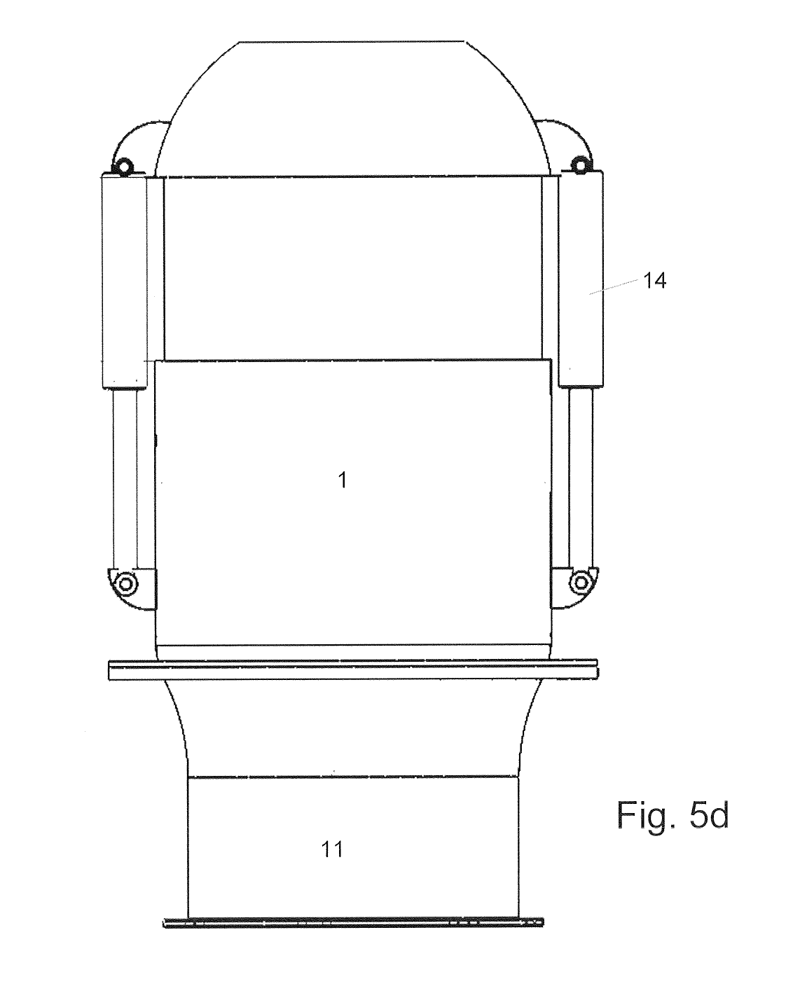

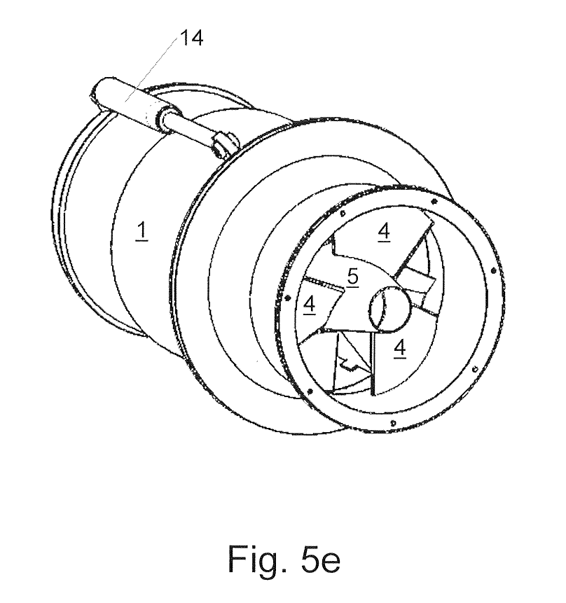

Referring now to FIGS. 5a and 5c, cylinder gate 1 is shown in the full open position. Stay vane portion 3b and guide vane portion 3a of stator vane 3 may be seen through the cylinder gate opening. Hydraulic cylinder 14 is shown in its fully retracted position.

Referring now to FIGS. 5b, 5d and 5e, Cylinder gate 1 is shown in its fully closed position while hydraulic cylinder 14 is shown in its fully extended position. Runner blades 4 and runner hub 5 are visible in FIG. 5e.

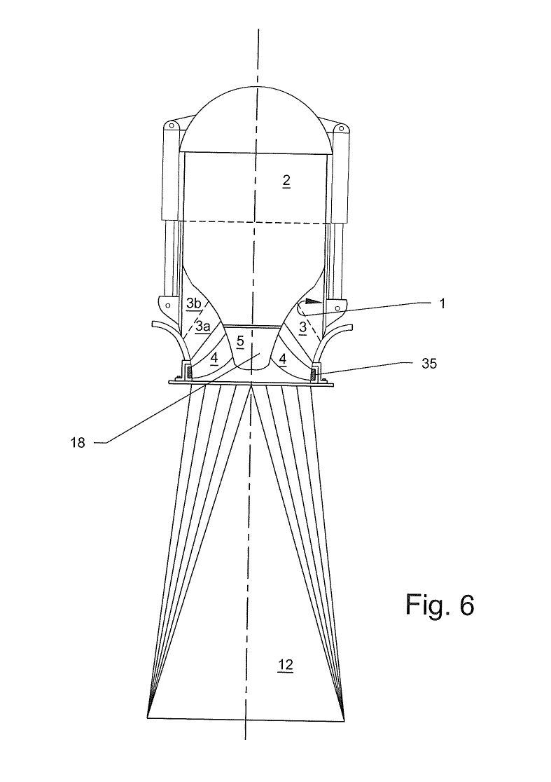

Referring now to FIG. 6, a submersible turbine generator set with a high specific speed Francis runner 18, comprised of hub 5, blades 4 and band 35 is shown in conjunction with cylinder gate 1 (shown closed). Because stator vanes 3 are not movable as in the case of a conventional prior art Francis turbine guide vanes, they may be skewed so as to guide flow radially (as well as tangentially) in order to control the radial distribution of velocity entering the runner 18. Draft tube 12 is also shown.

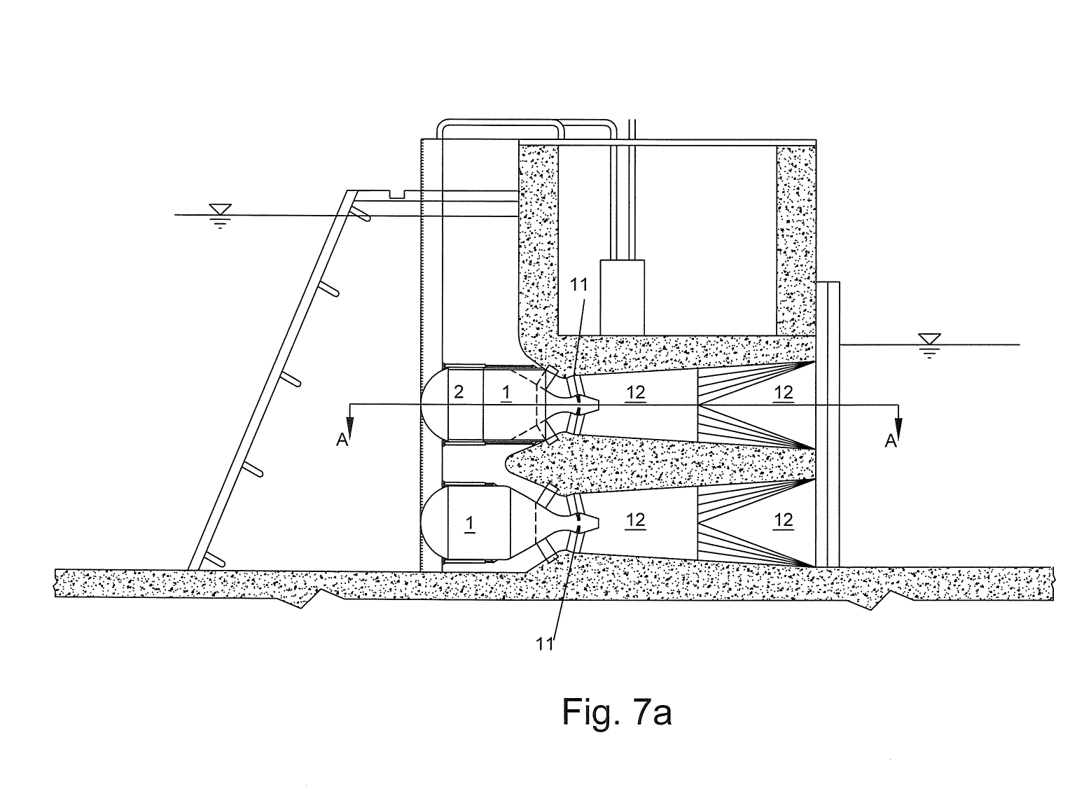

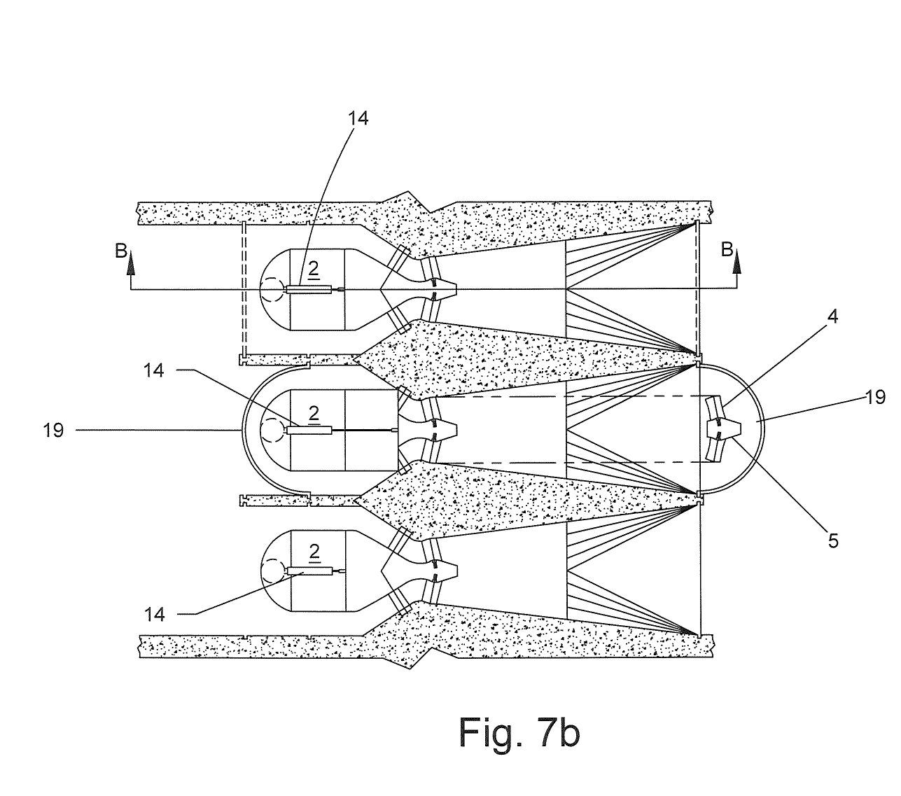

FIGS. 7a and 7b show a powerhouse that incorporates adjustable blade runners with the blades canted upstream in accordance with an embodiment of the present invention and with cylinder gates for shut off. Note that the runner may be removed through the draft tube without disassembly or removal of the discharge rings 11. The draft tubes 12 may be dewatered by means of semi-cylindrical draft tube bulkhead 19. The semi-cylindrical form of the bulkhead 19 minimizes bending moments on the bulkhead 19 imparted by hydrostatic loads. The open top of bulkhead 19 allows removal and replacement of runner including blades 4 and hub 5 with bulkhead 19 in place.

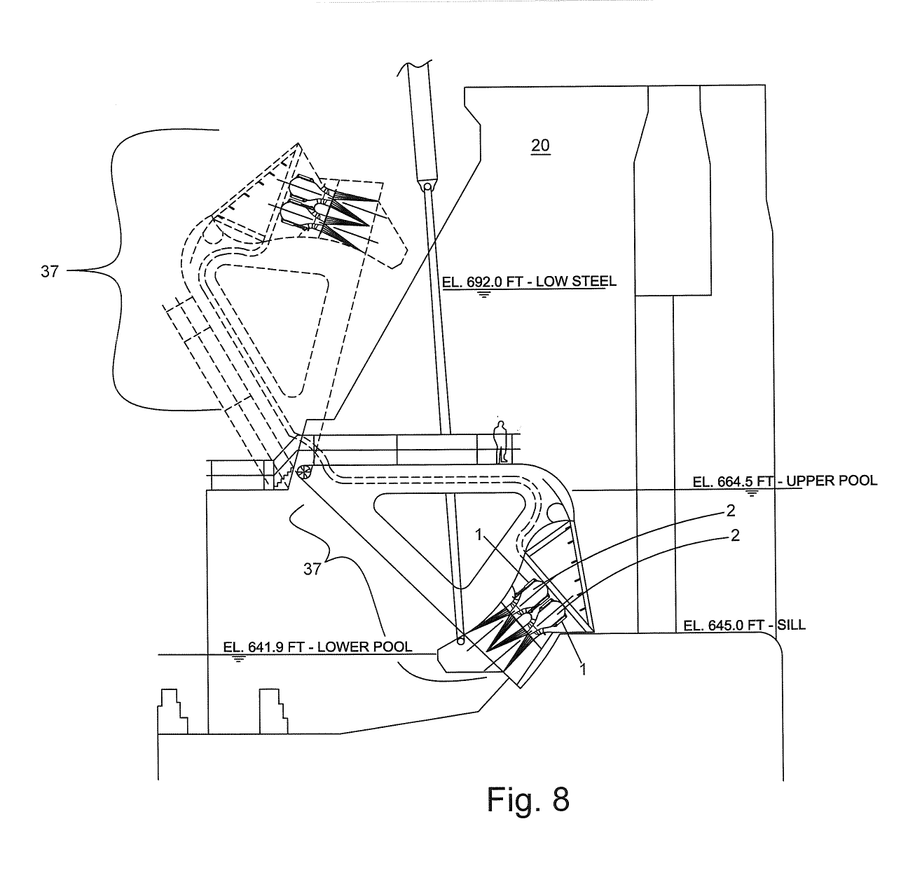

FIG. 8 shows turbine generator sets with cylinder gates 1 and generators 2 in conjunction with a hydroturbine assembly 37 configured to replace a submergible radial gate. Other hydroturbines configured to replace a submergible radial gates are disclosed in my U.S. application Ser. No. 11/986,584.

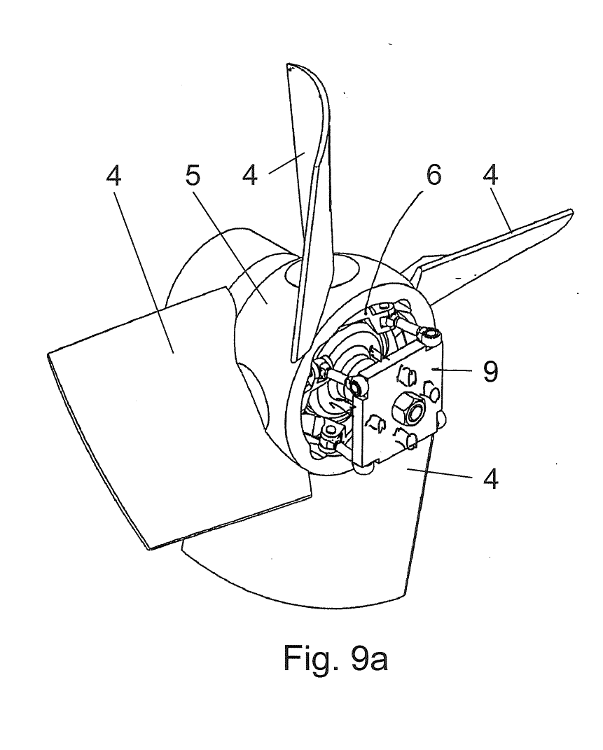

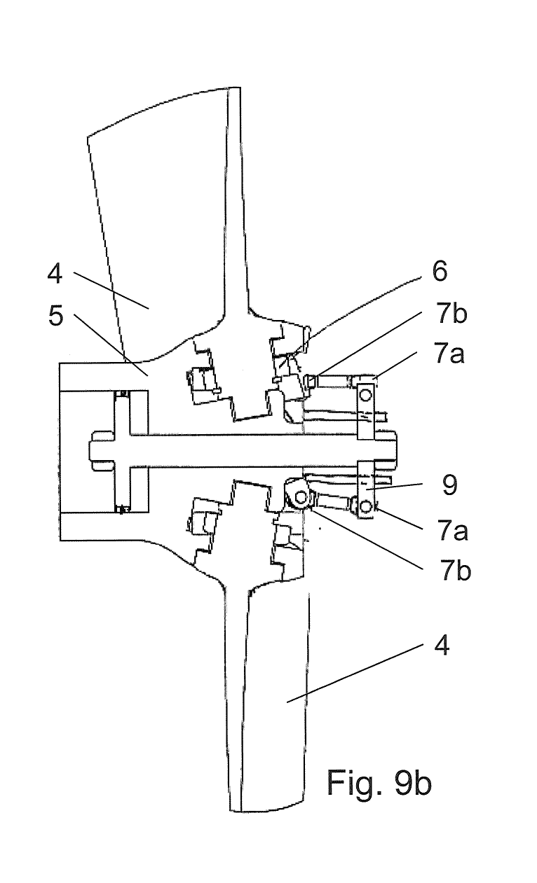

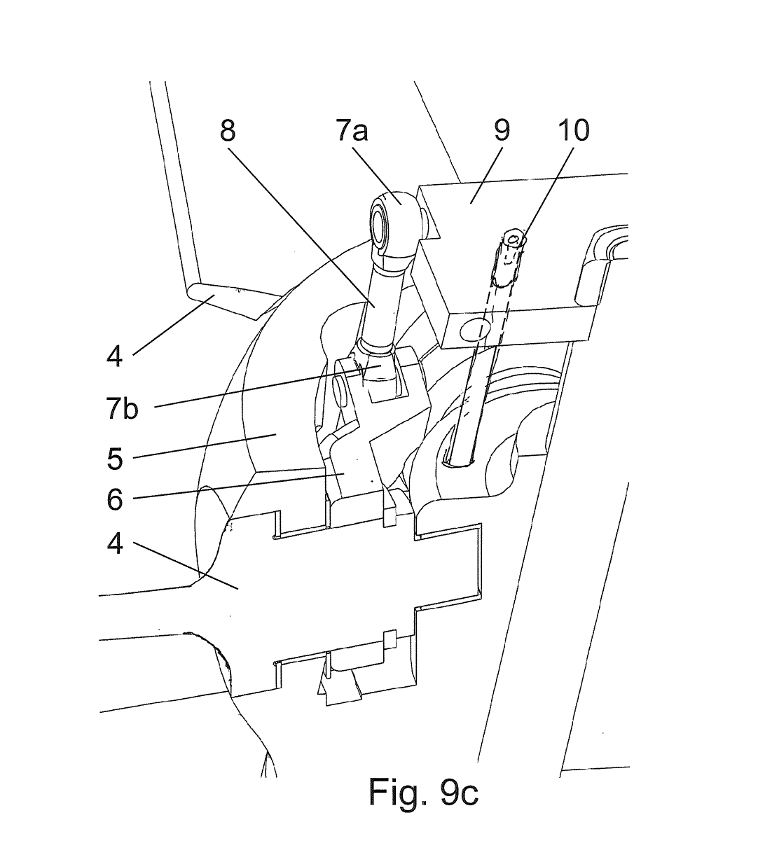

FIGS. 9a, 9b, and 9c show a high specific speed runner with blades 4, runner hub 5, blade levers 6, connecting links 8, spherical joints 7a and 7b, guide pins 10, and piston rod 21.

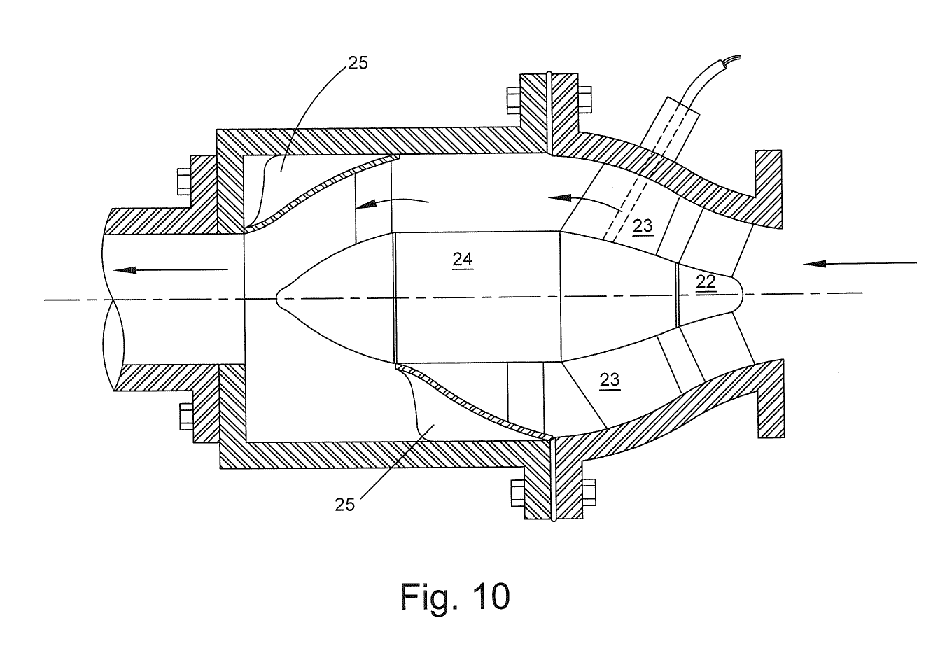

Referring now to FIG. 10 an axial flow pump is shown with impeller 22, diffuser vanes 23, motor housing 24, conical gate 25 shown open on the top half of the drawing and closed on the bottom half of the drawing.

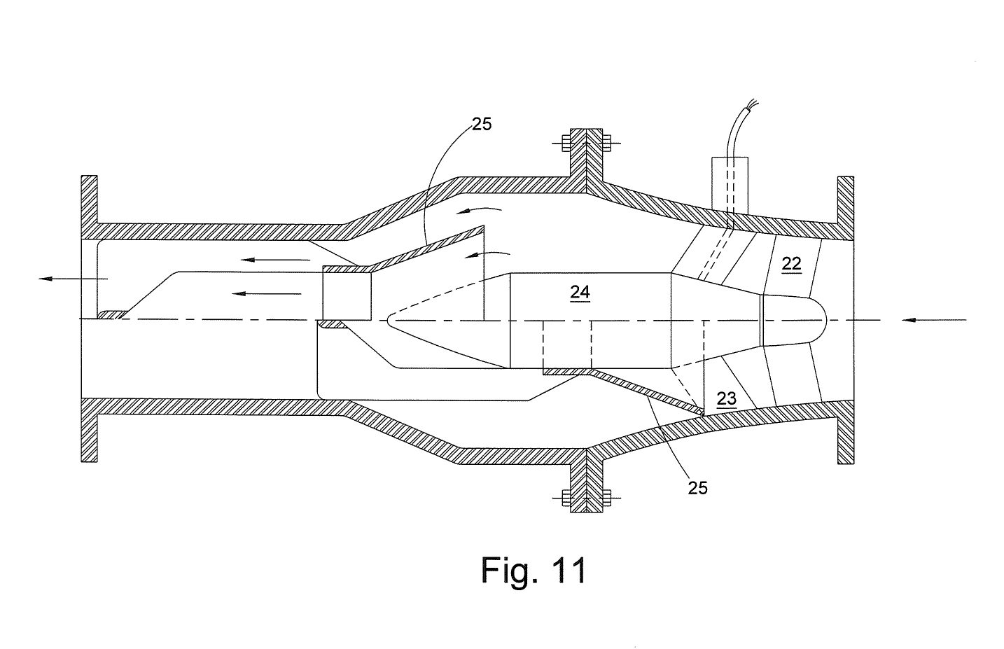

Referring now to FIG. 11, another pump is shown with conical gate 25, impeller 22 and diffuser vanes 23. Conical gate 25 is shown open on the top half of the drawing and closed on the bottom half of the drawing.

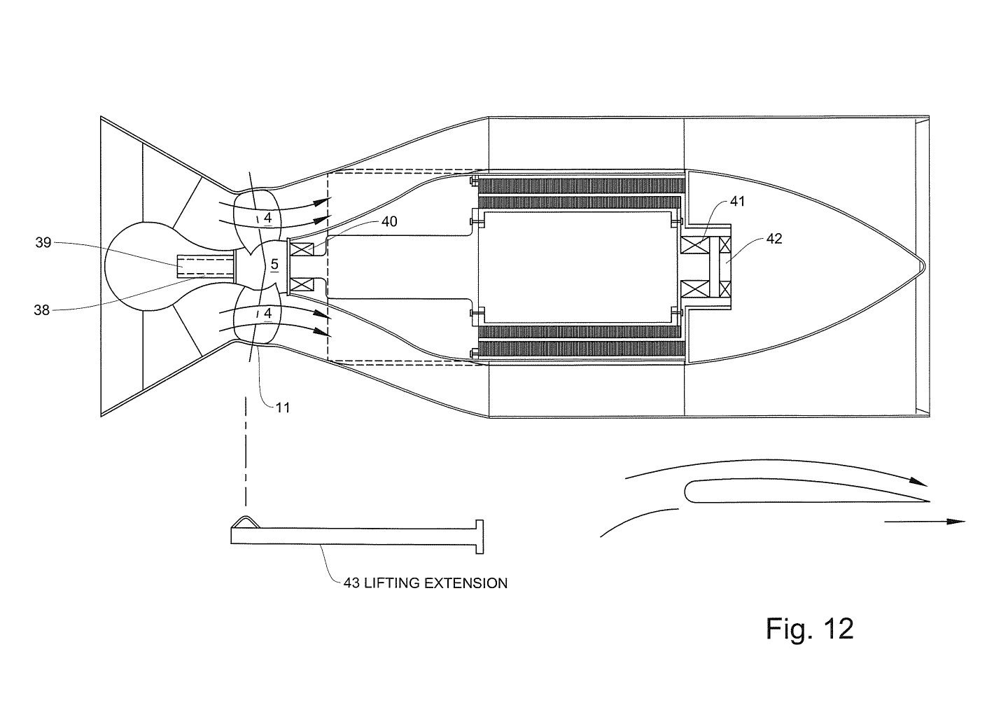

Referring now to FIG. 12, runner hub 5 holding canted blades 4 is located in spherical discharge ring 11. Shaft extension 39 is positioned by water lubricated guide bearing 38. The main shaft is positioned by upstream guide bearing 40, downstream guide bearing 41 and thrust bearing 42. Lifting extension 43 may be substituted for shaft extension 39 during machine assembly and disassembly.

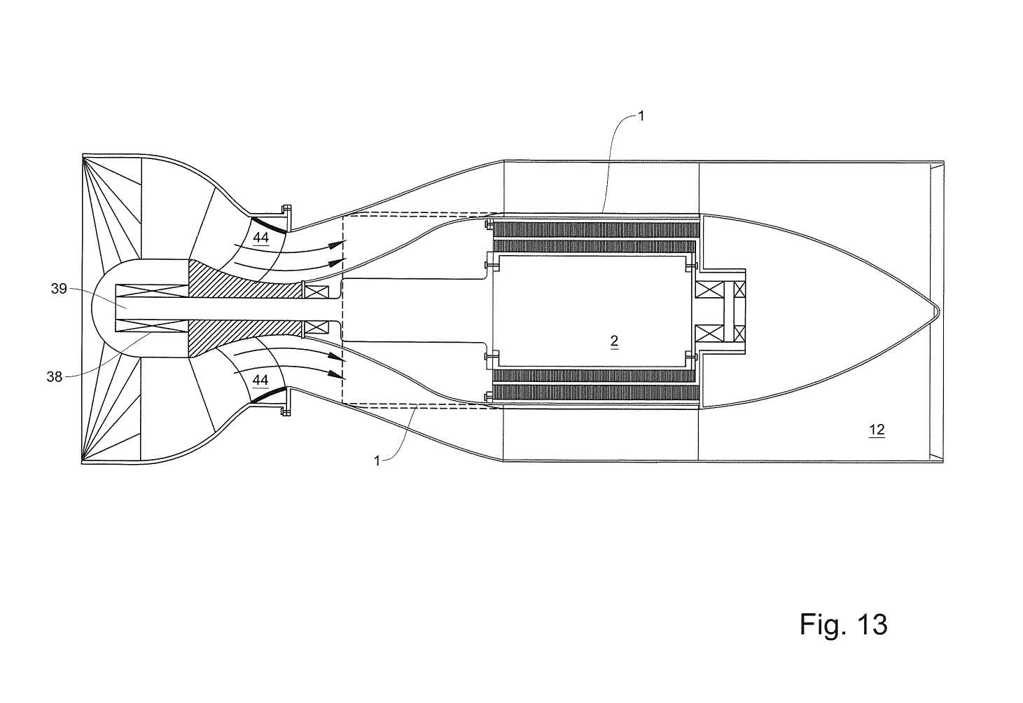

Referring now to FIG. 13, a submersible hydroturbine with a cylinder gate 1 and generator 2 in the draft tube 12 in conjunction with a Francis runner 44. Such a machine is useful, for example, for developing power at existing gated structures where one or more such machines or an array of such machines may be installed in series with the pre-existing water control gates.

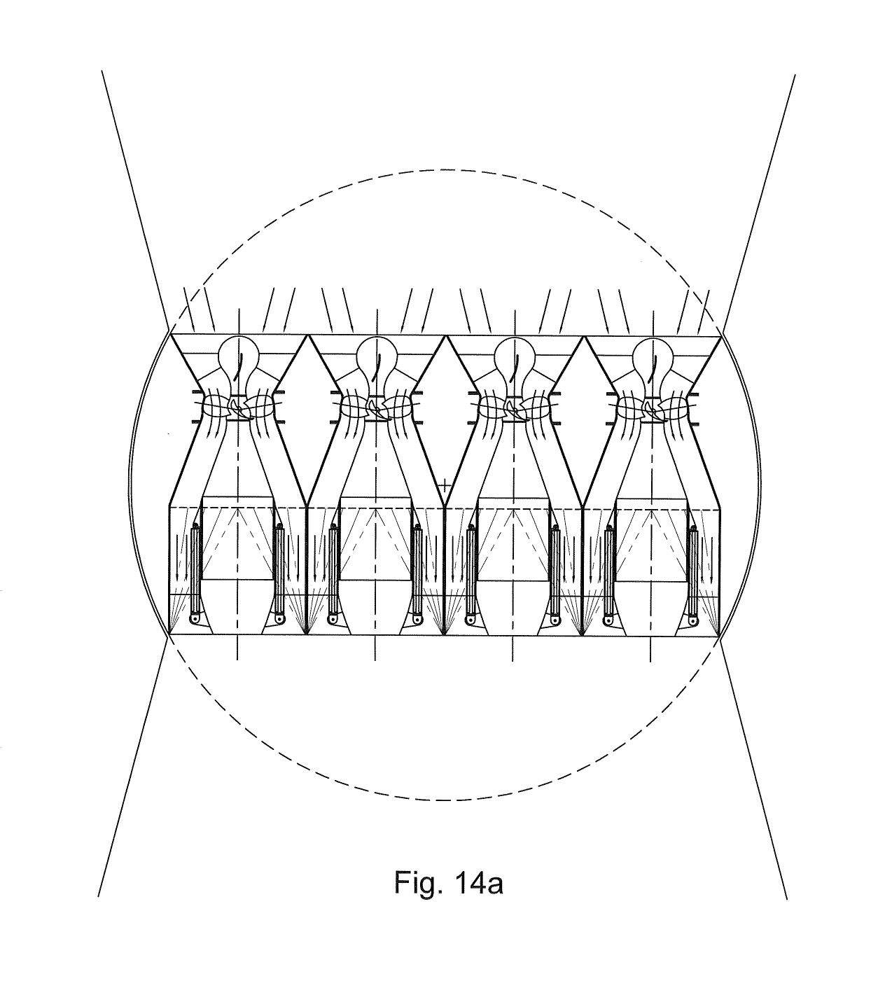

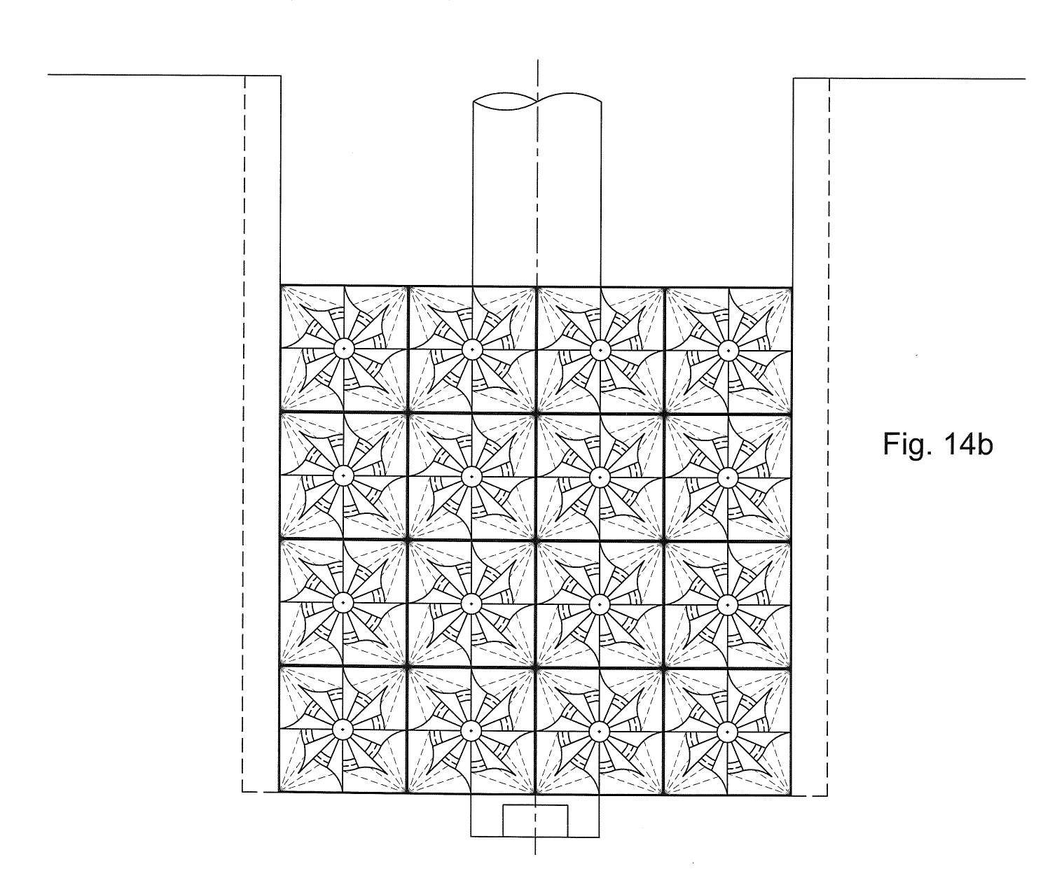

Referring now to FIG. 14a, an array of hydroturbines that utilize flows in either direction by being rotated 180 degrees about a vertical axis are shown in cutaway plan view. The size and weight of such an array of hydroturbines are much less than the size and weight of a single hydroturbine of equivalent capacity. Making the facility reversible is thus facilitated. Keeping the same optimized geometry for each direction of flow provides maximum efficiency in each direction. The use of permanent magnet generators operated at variable speed provides high efficiency over a wide range of available head, such as may be available in conjunction with a tidal energy plant. FIG. 14b shows a view of the inlet end of the array of turbines of FIG. 14a.

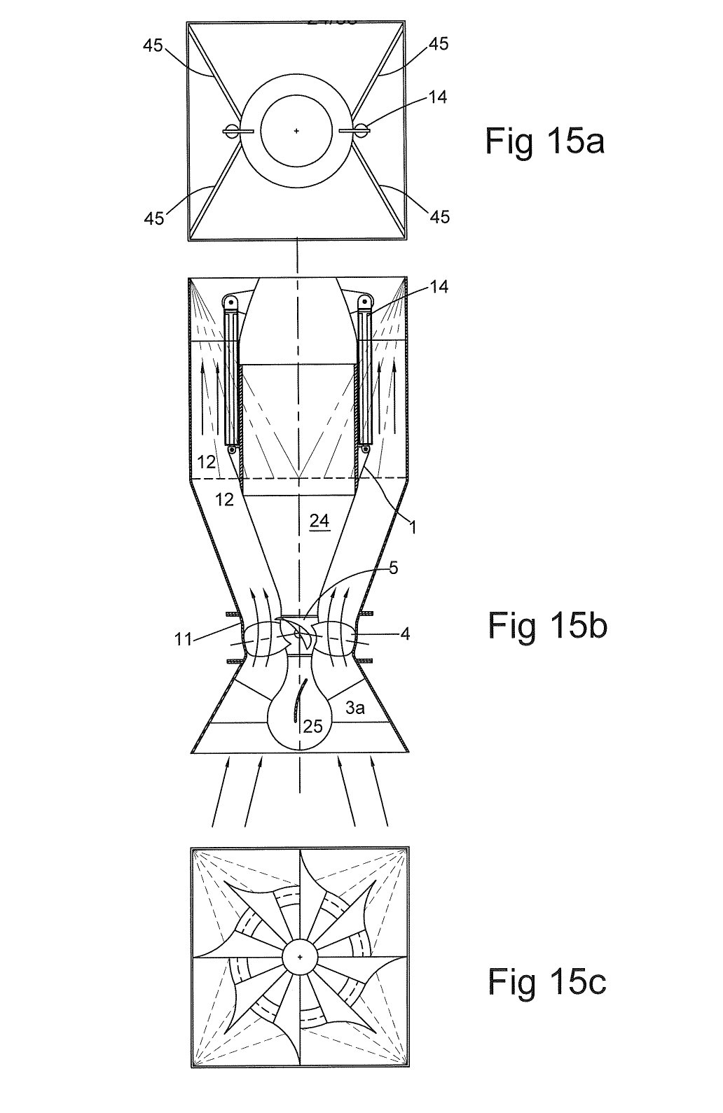

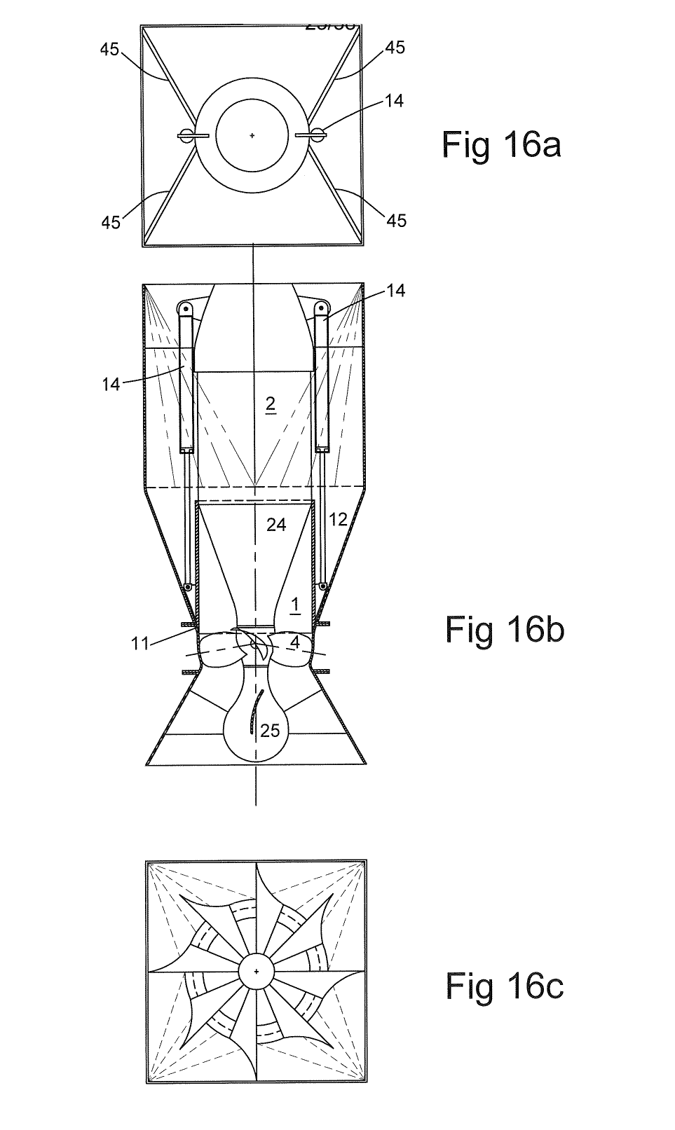

Referring now to FIGS. 15a, 15b, and 15c of a hydroturbine with an adjustable runner 4,5 with canted blade pivot axes, generator 2 in the draft tube 12, and a cylinder gate 1 is shown in the open position shown in exit end view, sectional elevation view, and entry end view, respectively. The generator 2 is positioned in the draft tube 12 by stay vanes 45. FIGS. 16a, 16b, and 16c are the same views as FIGS. 15a, 15b, and 15c, except with the cylinder gate 1 shut.

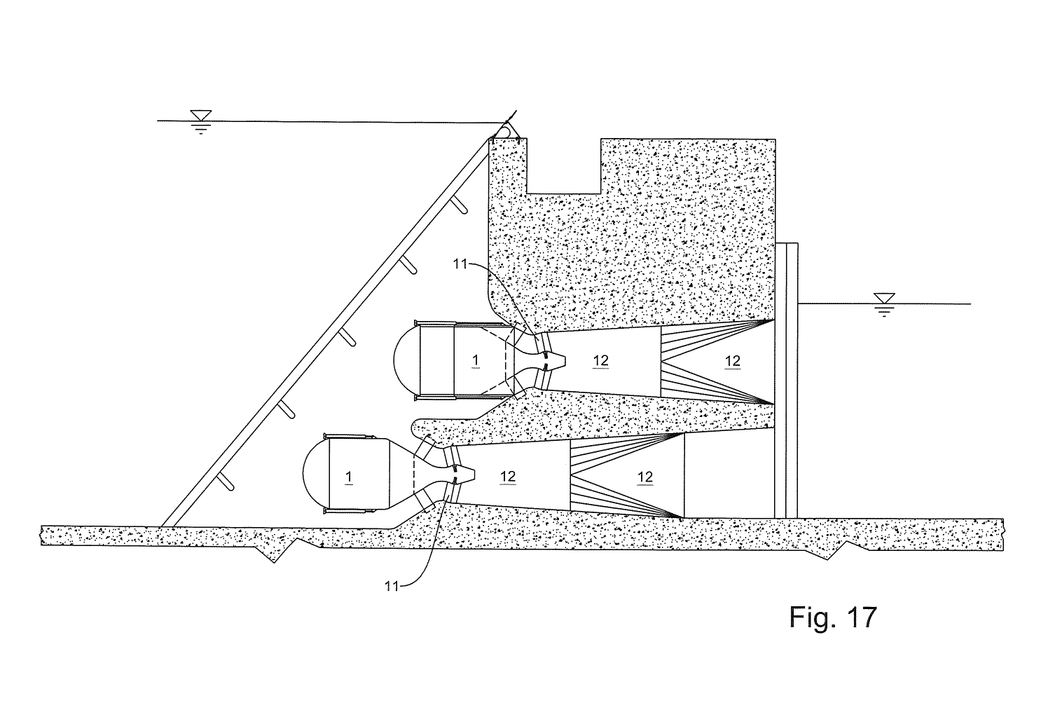

Referring now to FIG. 17, a hydropower plant is shown with two staggered rows of turbines, one above the other. Such an arrangement provides independent and direct crane lifting access to both upper and lower machines. The more deeply submerged machines in the lower row may use higher specific discharge runners which benefit from the longer draft tube available to the lower row machines.

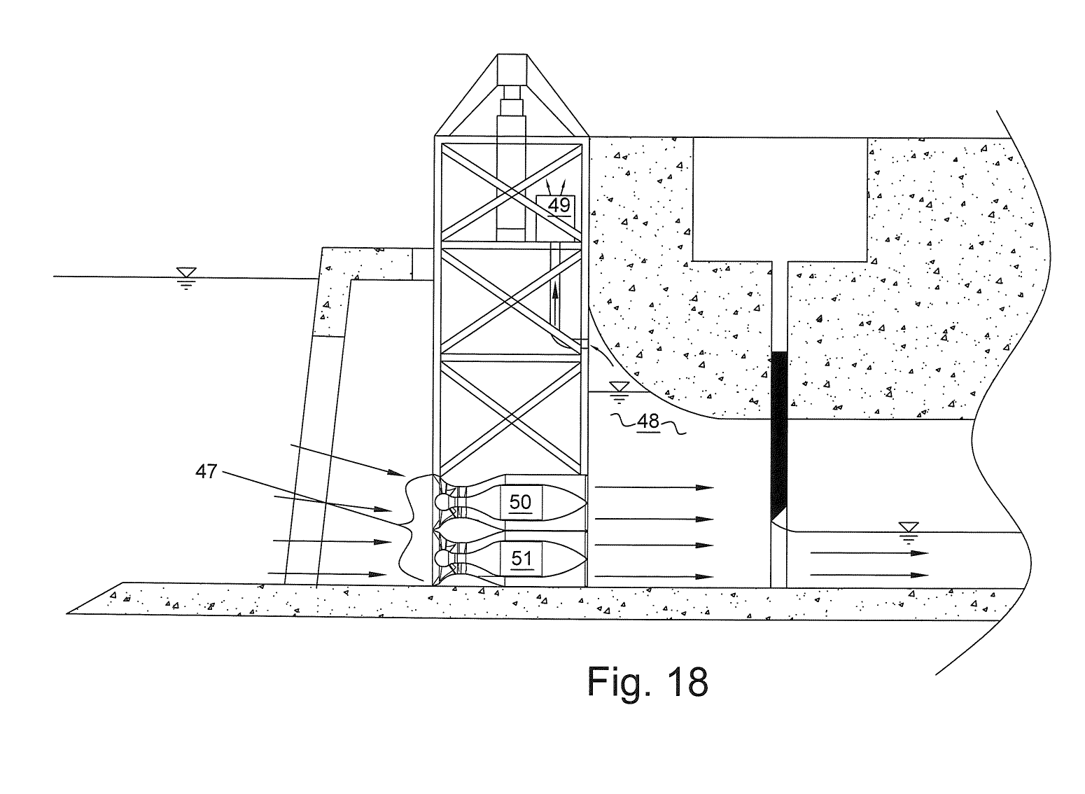

Referring now to FIG. 18, an array of hydroturbines installed in a gate service stop log slot is shown in conjunction with which air is evacuated from the water passageway 48 between the turbine array 47 and a downstream control gate 46. This allows operation of the upper row 50 with draft tube submergence, but with the same head as lower row 51. Air evacuation may be by means of naturally occurring air entrainment in conjunction with prevention of air leakage, especially at the seals of gate 46. Alternatively, a vacuum pump 49 such as a liquid ring pump with water as the working fluid may be used to evacuate the air from water passageway 48.

Referring now to FIG. 19, the use of multiple air gap axial flux permanent magnet generators 50 in conjunction with cylinder gates 1 and mixed flow runners 44 is illustrated.

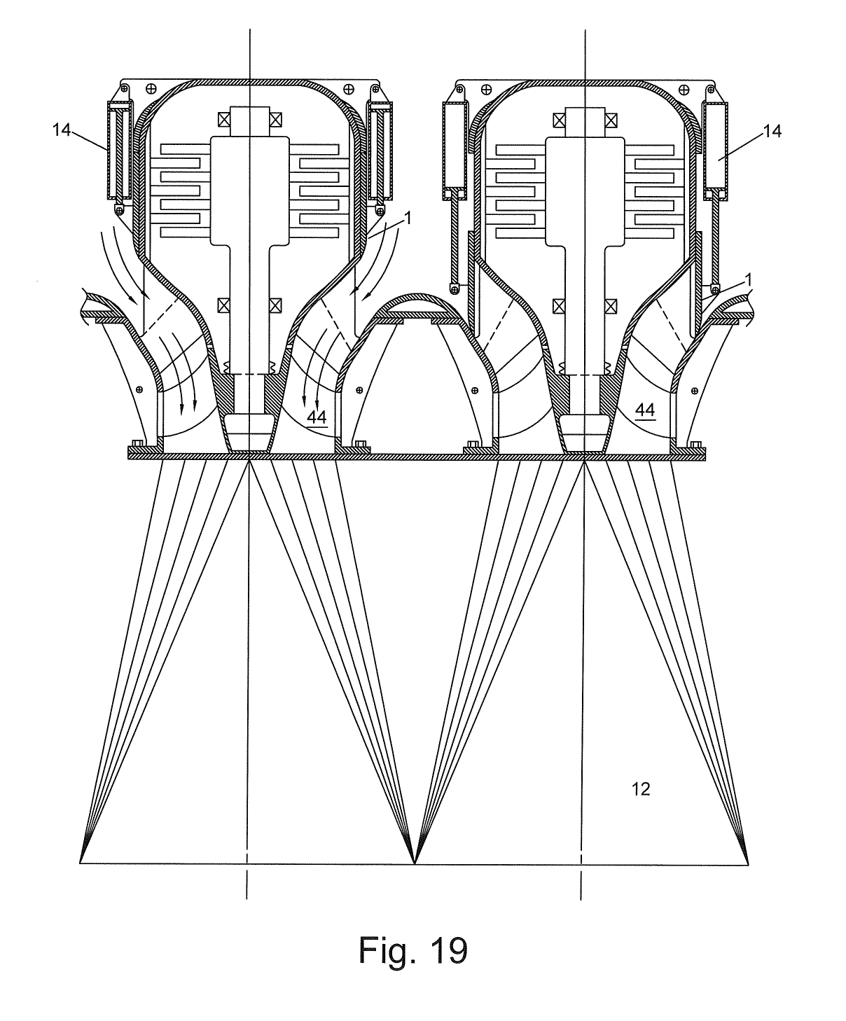

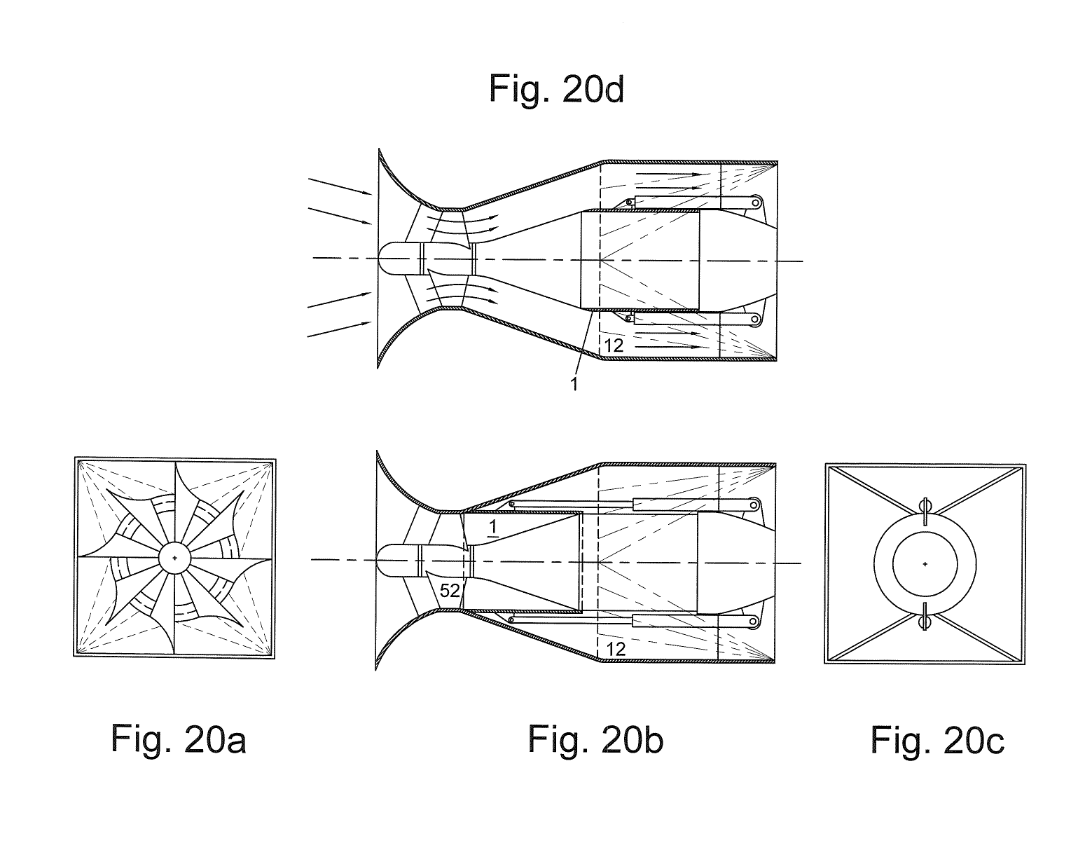

Referring now to FIGS. 20a, 20b, 20c and 20d a hydroturbine with the generator and cylinder gate 1 in the draft tube 12 in conjunction with a fixed pitch runner 52 is illustrated. The overall length of this configuration is less than for a machine with the generator located upstream. The overall length is critical to installing such machines into existing structures with limited upstream/downstream space.

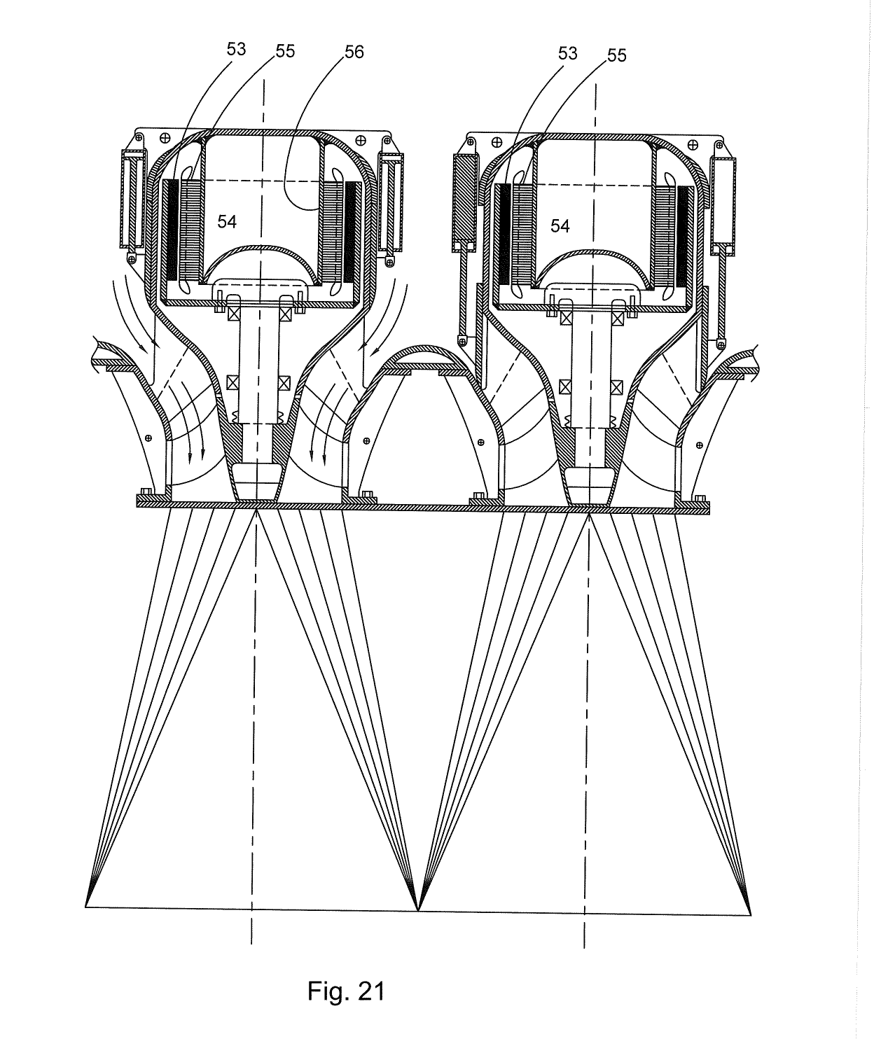

Referring now to FIG. 21, the use of an external rotor permanent magnet generator in conjunction with hydroturbine in accordance with the present invention is illustrated. Permanent magnet rotors 53 are provide for more secure attachment of permanent magnets to the rotor than for a similar machine with an internal rotor. This is particularly important for over-speed conditions that normally follow a load rejection. Cooling of the stator 55 may be readily provided by a heat pipe and stator hub 54 with wicked surfaces 56 adjacent to the stators 55. Alternatively, water may be allowed to circulate within the stator hub 54.

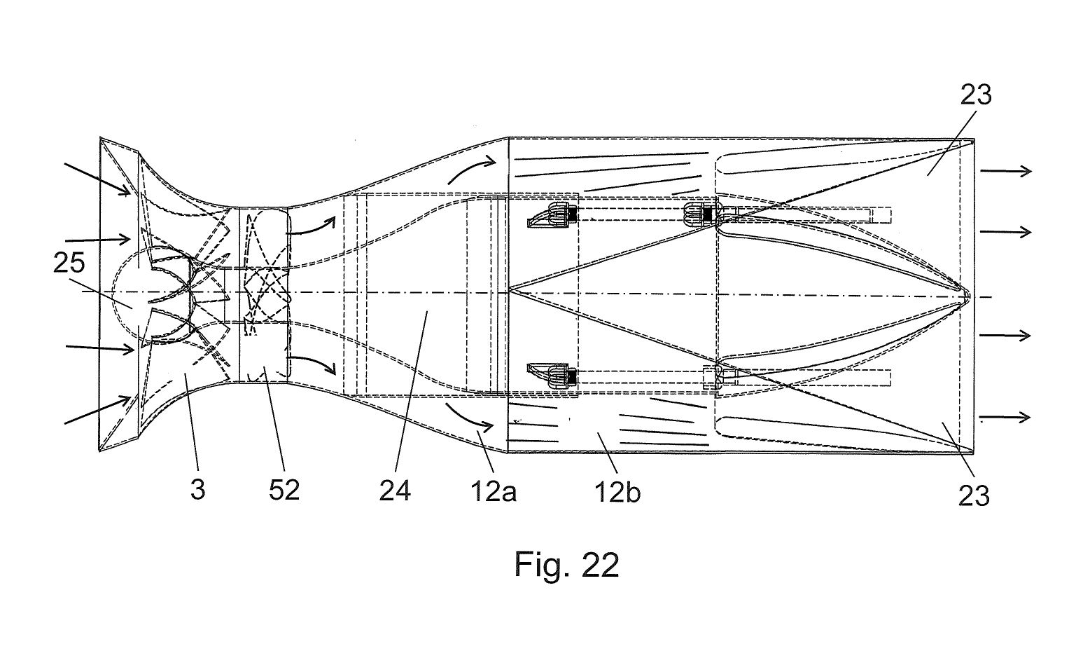

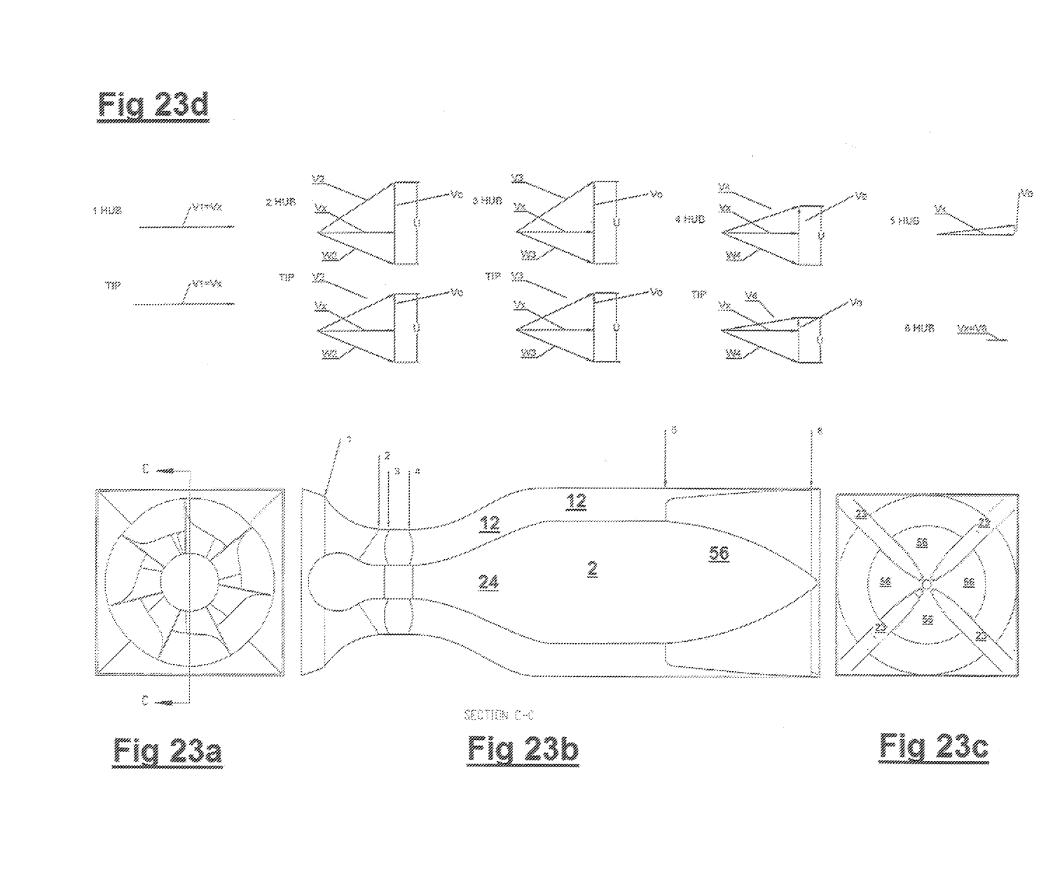

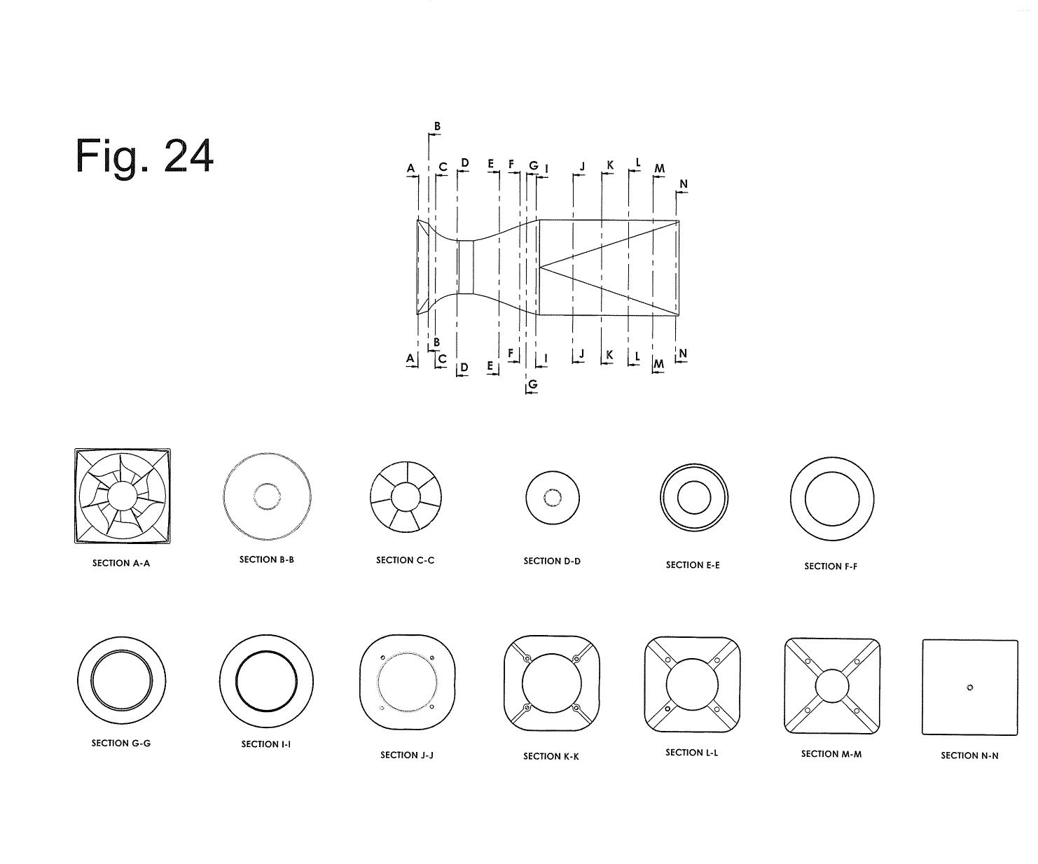

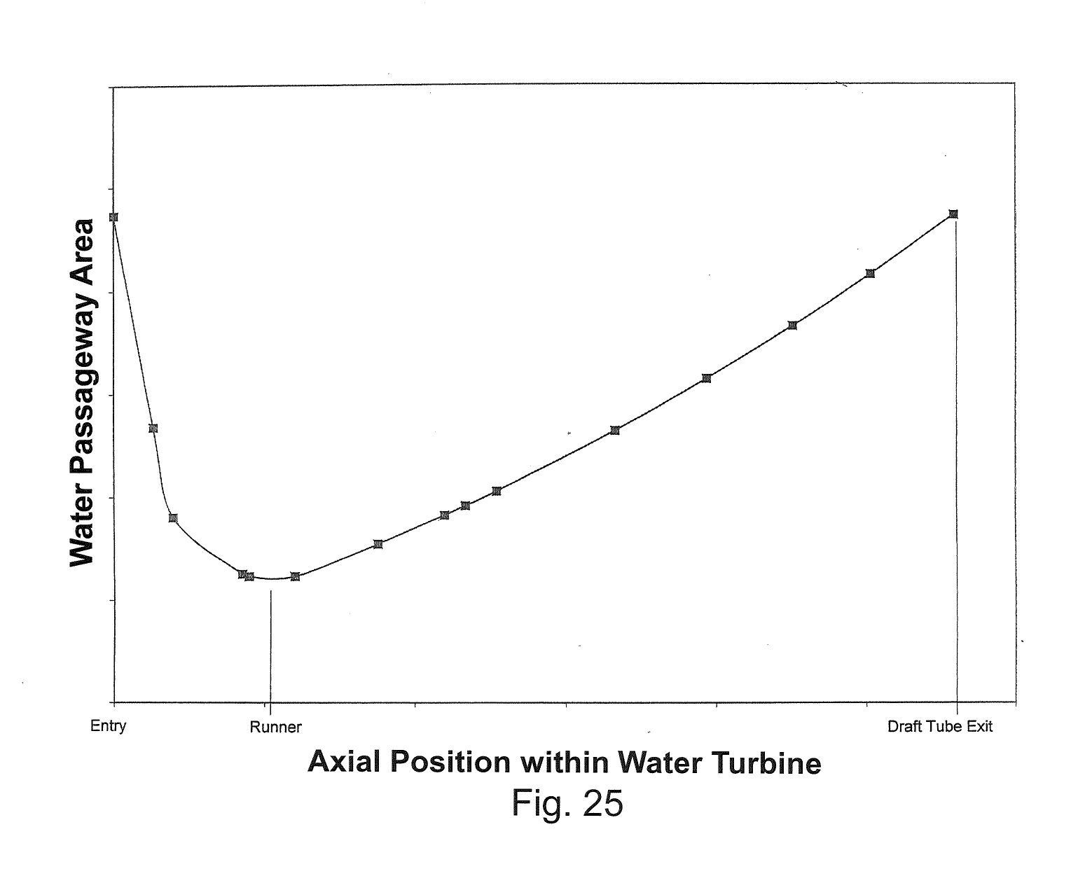

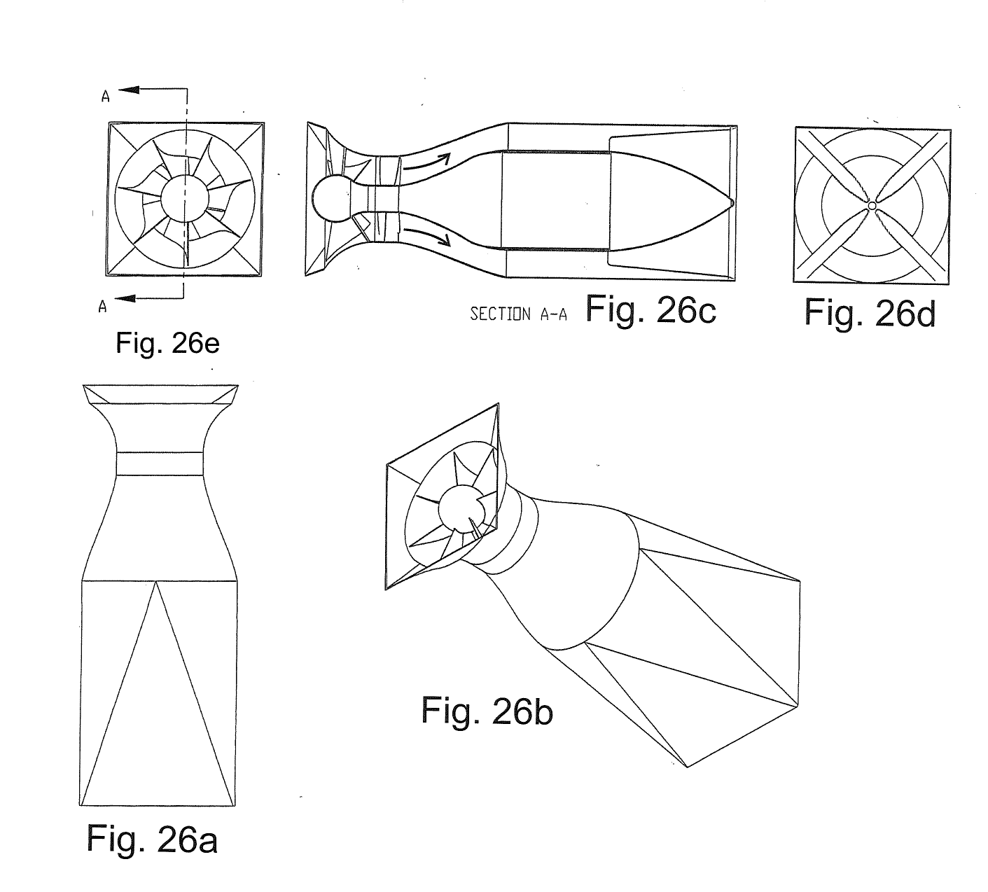

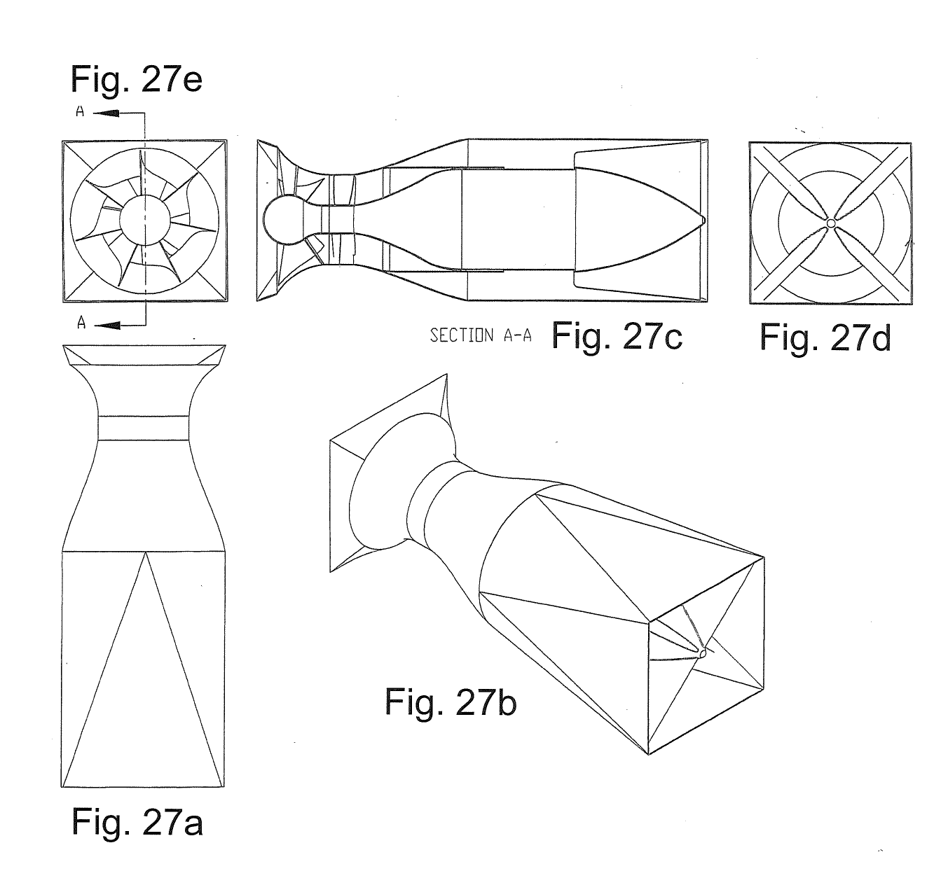

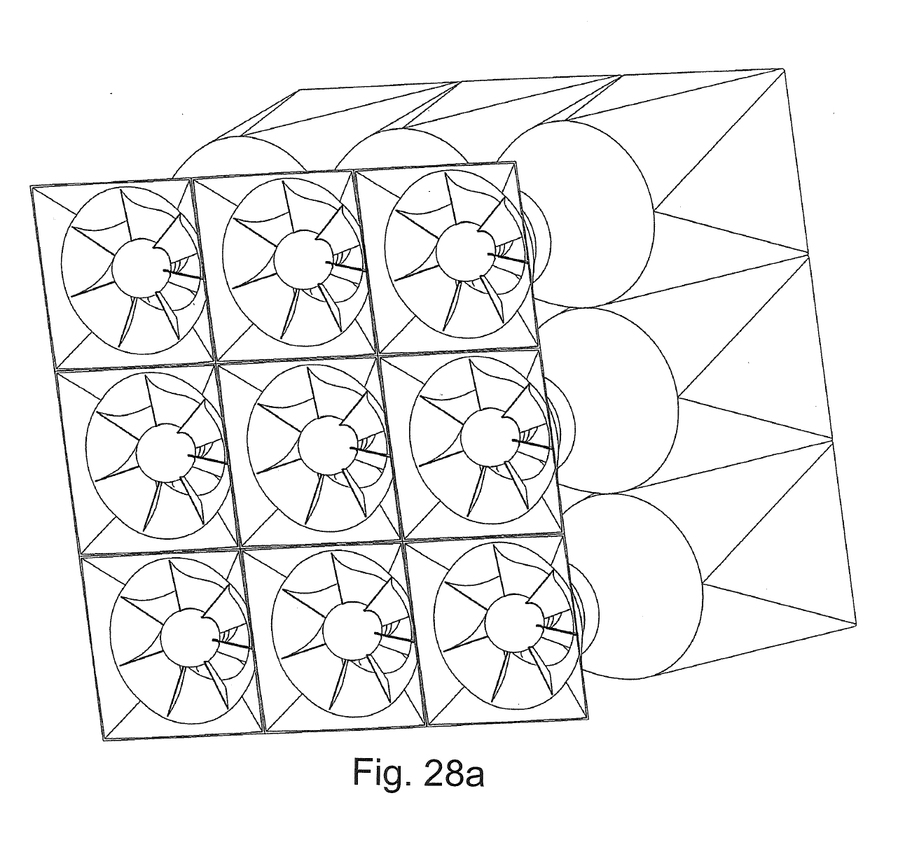

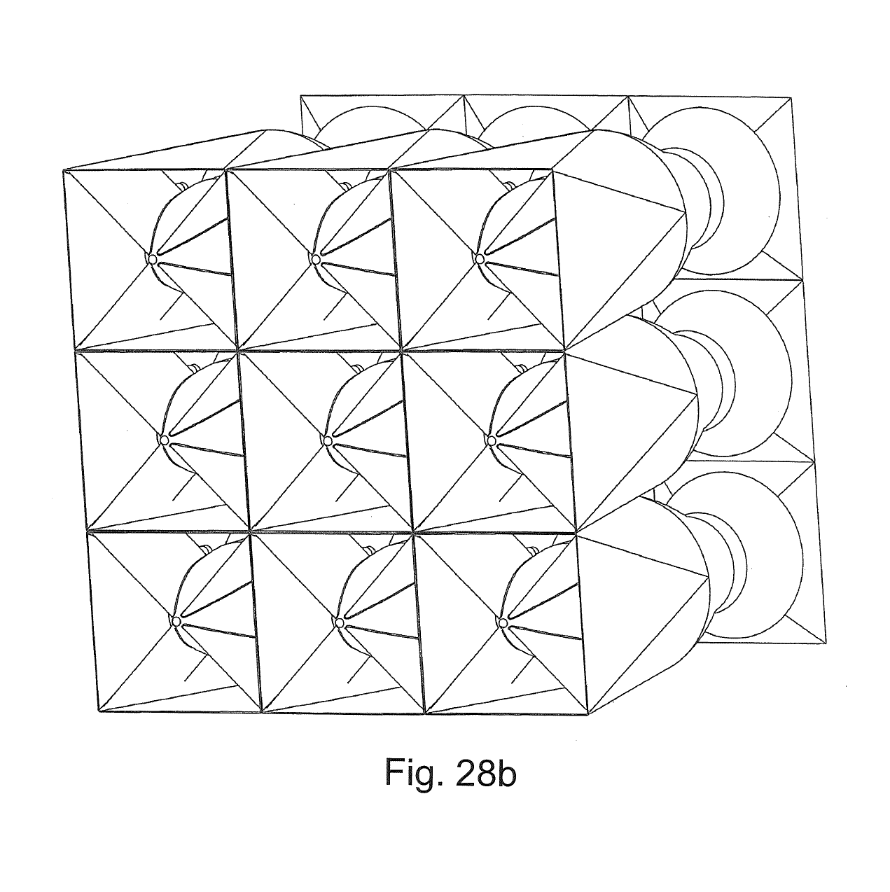

Referring now to FIGS. 22, 23a, 23b, 23c, 24, 26a, 26b, 26c, 26d, 26e, 27a, 27b, 27c, 27d, and 27e a turbine with a cylinder gate 1 stowed when open around a generator 2 located within the draft tube 12 is shown in various views. The illustrated machine has a short overall length by virtue of the generator being located within the draft tube. The efficiency of the machine is enhanced because the profile loss at the end of the runner hub fairing is absent. In lieu of using a runner hub fairing, the draft tube 12 works in conjunction with diffuser hub 24 to recover both axial and tangential kinetic energy from the water leaving the runner 52. The proportions of the draft tube 12 and diffuser hub 24 are carefully coordinated to provide a steady and gradual change in discharge area from the runner to the draft tube exit in accordance with FIG. 25, in a manner similar to that provided by an optimized straight conical draft tube but with an improved ability to recover residual tangential kinetic energy from the runner discharge nearest the runner hub. Highest axial flow turbine efficiencies generally occur with at least some residual forward (in the direction of runner rotation) swirl. This is because the energy loss on the runner due to drag is proportional to the velocity relative to the runner cubed. Designing for a small amount of forward swirl results in a net efficiency benefit, even though a portion of the tangential velocity is not recovered in a conventional draft tube. Because of conservation of angular momentum, forward swirl in water leaving the blade tips is largely recovered because of the increase in draft tube diameter over its length. The water entering the draft tube near the outer wall of the draft tube reaches the end of the draft tube at a greater radius than that at which it entered. Its tangential velocity naturally decreases as it progresses to a greater radius. Conversely, flow leaving the runner blades nearest the runner hub tries to follow the runner fairing to an ever smaller radius. Any tangential velocity present in the water as it left the blades is multiplied as it tries to fill the void in the wake of the runner hub fairing. The energy lost in the resulting vortex results in runner hub fairings being truncated to reach the best overall efficiency. FIGS. 23a, 23b, and 23c show inlet end, cut-away, and exit end views of the turbine of FIG. 22. FIG. 23d shows velocity triangles at stations 1, 2, 3, 4, and 5 for the turbine of FIGS. 23a, 23b, and 23c. Aside from the overall length advantage of the illustrated hydroturbine configuration, an efficiency advantage is available as well. Representative velocity triangle are illustrated for various station along the length of the machine. Both hub and tip tangential velocities are reduced by the diffuser comprised of the draft tube 12 and the diffuser hub 24. Diffuser vanes 23 are located in a zone of sufficiently low velocity so as to not themselves contribute significant losses to the machine. They provide an efficiency benefit be straightening the flow so that as the flow follows the generator fairing 56 there is no more tangential component that would result in a tangential acceleration and loss of energy. FIG. 24 shows cross sections of the turbine of FIGS. 22 and 23a, 23b, and 23c. Coordination of dimensions between the difusser fairing, the conical portion of draft tube 12, the round-to-square portion of draft tube 12, the generator fairing 56 and the diffuser vanes 23 results in an increase in area gradual enough to prevent flow separation within the draft tube. Optionally, vortex generating vanes or texture may be used just upstream of the generator fairing 56 in order to re-energize the boundary layer at this location. FIG. 25 shows approximate water passageway area as a function of axial position through the water turbine of FIGS. 22, 23a,23b, and 23c. FIG. 26 shows the water turbine of FIGS. 22, 23a,23b, and 23c with the cylinder gate open. FIG. 27 shows the water turbine of FIGS. 22, 23a,23b, and 23c with the cylinder gate closed. FIG. 28 shows the inlet end of an array comprised water turbines similar to the one shown in FIGS. 22, 23a, 23b, and 23c. FIG. 29 shows the outlet end of an array comprised water turbines similar to the one shown in FIGS. 22, 23a, 23b, and 23c.

1. A submersible hydroturbine-generator set including a cylinder gate movable between an open position surrounding the generator housing and a closed position sealed to the generator housing and sealed to the distributor shroud or extension thereof.

2. A hydroturbine with adjustable blades wherein the blades axes are not in a radial plane, but are instead canted such that the intersection of each blade pivot axis at the discharge ring is further upstream than the intersection of each blade pivot axis at its closest point to the main shaft centerline.

3. The hydro turbine of claim 2 wherein the blades are canted between 5 and 25 degrees.

4. The hydroturbine of claim 2 further comprising a discharge ring spherical upstream of the runner centerline only.

5. The hydroturbine of claim 4 further comprising a water passageway inner surface of a diameter less than 80% of the maximum hub diameter occurring between the guide vanes and the runner blades.

6-9. (canceled)

10. At least two hydromotive machines, each comprising
1) An inner water passageway surface upstream of the guide vanes,
2) a common pressure plenum between at least two of said at least two hydroturbines,
3) cylinder gates stowable when open around said inner water passageway surface and sealable when closed between said inner water passageway surface and a distributor shroud or extension thereof.

11. The apparatus of claim 9, wherein the hydromotive machines are hydroturbines.

12. The apparatus of claim 9, wherein the hydromotive machines are pumps.

13. The apparatus of claim 9, wherein the hydromotive machines are reversible pump-turbines.

14-16. (canceled)
